(19) United States
(12) Patent Application Publication
(10) Pub. No.: US 2010/0299183 A1
(43) Pub. Date: Nov. 25, 2010

(54) Device and Method for Creating, Distributing, Managing and Monetizing Widgets Including Streaming

(76) Inventor: Robb Fujioka, Manhattan Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/783,172

(22) Filed: May 19, 2010

Related U.S. Application Data
(60) Provisional application No. 61/216,717, filed on May 20, 2009.

(51) Int. Cl. G06F 15/16; G06F 3/14; G06F 15/173; G06Q 10/00; G06Q 50/00

(52) U.S. Cl. 705/10; 709/231; 715/716; 709/224

(57) ABSTRACT

A computerized development method, system and apparatus for creating a widget designed to control streaming media are disclosed. The method, system and apparatus include creating a widget to control streaming media, the widget including a widgetized existing code element, distributing the created widget, reporting and tracking the distributed widget, wherein the reporting and tracking the distributed widget enables access to how the created widget is being used via analytics of the created widget, and monetizing the widget to generate revenue based on the created, distributed, and reported and tracked widget.

This application claims priority to: U.S. application Ser. No. 61/216,717 entitled “A Device And Method For Creating, Distributing, Managing And Monetizing Widgets Including Streaming” filed May 20, 2009, the entire disclosure of which is hereby incorporated by reference as being set forth in its entirety herein; U.S. patent application Ser. No. 12/586,884, filed on Sep. 29, 2009 entitled “A Device and Method for Creating, Distributing, Managing and Monetizing Widgets and U.S. patent application Ser. No. 12/568,904, filed Sep. 29, 2009 entitled “Device and Method for Creating, Distributing, Managing and Monetizing Widgets”, each of which application claims priority to U.S. Provisional Application No. 61/210,190 entitled “A Device and Method for Creating, Distributing, Managing and Monetizing Widgets,” filed Mar. 12, 2009, each of which application having the entire disclosure incorporated by reference herein as if set forth in its entirety; and U.S. application Ser. No. 12/755,818 entitled “A Device and Method For Creating, Distributing, Management and Monetizing Widgets Using Templates” filed Apr. 7, 2010, which claims priority to U.S. application Ser. No. 61/212,129 filed Apr. 7, 2009, entitled “A Device and Method for Creating, Distributing, Managing and Monetizing Widgets Using Templates,” the entire disclosure of which is hereby incorporated by reference as being set forth in its entirety herein.

### FIELD OF THE INVENTION

This application is directed to the use and creation of widgets, and more particularly to a mechanism that is designed to create, distribute, manage and monetize widgets including streaming.

### BACKGROUND OF THE INVENTION

In the current art, a true capturing of personal attributes and tying them to a content portability device is not available. This is due, in part, to the lack of a convenient interface that allows people to operate a widget over multiple platforms and interfaces and allows for the portability of content from one place to the next. For example, a user would be well served to have a personalized widget that would retain certain characteristics entered by the user and learned by the widget through the use by the user and be able to work cross multiple sites of interest to the user. Not only would such a widget provide some uniformity to an otherwise chaotic environment, but would also allow the user to distribute and move content.

Thus, there exists a need for a method of creating, maintaining, monetizing and reporting widgets and its underlying architecture for the purpose of providing a user with the ability to control the flow of personal and third party information.

### SUMMARY OF THE INVENTION

A computerized development method, system and apparatus for creating a widget designed to control streaming media are disclosed. The method, system and apparatus include creating a widget to control streaming media, the widget including a widgetized existing code element, distributing the created widget, reporting and tracking the distributed widget, wherein the reporting and tracking the distributed widget enables access to how the created widget is being used via analytics of the created widget, and monetizing the widget to generate revenue based on the created, distributed, and reported and tracked widget.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates content links that are authorized for incorporation into the widget, or a dropdown menu from which the user can select authorized types of content for that portion of the widget, or a hierarchal dropdown menu from which the user may select a top level, and subsequently more specific levels of allowed content from the available authorized content according to an aspect of the present invention;

FIG. 2 illustrates a widget that may be designed for interest in, or capability of, playing within the widget of particular video games according to an aspect of the present invention;

FIG. 3 illustrates a widget for specific geographic locations that may access the location of the user requesting the use of that particular widget, such as by the physical location of the IP address of such user, and may fill in the selected widget based on the user's geographic location according to an aspect of the present invention;

FIG. 4 illustrates a flow diagram including a widget aggregator according to an aspect of the present invention;

FIG. 5 illustrates a widget used in a television or DVR computing community according to an aspect of the present invention;

FIG. 6 illustrates that the subject widget may be published into an active program according to an aspect of the present invention;

FIG. 7 is a display of the widget creator according to an aspect of the present invention;

FIG. 8 is a display of a widgetizer configured to grab content, make the content into a widget and share the widget according to an aspect of the present invention;

FIG. 9 is a display of a flash URL input into the widgetizer according to an aspect of the present invention;

FIG. 10 is a display of a HTML/JS URL input into the widgetizer according to an aspect of the present invention;

FIG. 11 is a display of a gadget input into the widgetizer according to an aspect of the present invention;

FIG. 12 is a display of a template input in the widgetizer according to an aspect of the present invention;

FIG. 13 is a display of the converter configured to grab content, make the content into a widget and share the widget according to an aspect of the present invention;

FIG. 14 is a display of an image URL input into the converter according to an aspect of the present invention;

FIG. 15 is a display of a blog/feed URL input into the converter according to an aspect of the present invention;

FIG. 16 is a display of a webpage URL input into the converter according to an aspect of the present invention;

FIG. 17 is a display of resources available to publish widgets to galleries, websites, or send them via email according to an aspect of the present invention;

FIG. 18 is a display of a widget editing according to an aspect of the present invention;

FIG. 19 is a display of methodologies of the present invention that allow for the distribution of widgets;

FIG. 20 is a display of the post/share methodology employed to distribute the widget according to an aspect of the present invention;

FIG. 21 is a display of the beginning to the publishing and distributing of a widget to a face book page according to an aspect of the present invention;

FIG. 22 is a display of distribution performed using a gallery to post the widget according to an aspect of the present invention;

FIG. 23 is a display of the methodologies of reporting according to an aspect of the present invention;

FIG. 24 is a display of the traffic views according to an aspect of the present invention;

FIG. 25 is a display of live traffic according to an aspect of the present invention;

FIG. 26 is a display of the traffic monitoring using the number of clicks according to an aspect of the present invention;

FIG. 27 is a display of time on the widget displayed as a function of the day according to an aspect of the present invention;

FIG. 28 is a display of traffic associated with clickthroughs according to an aspect of the present invention;

FIG. 29 is a display of the activity by custom events according to an aspect of the present invention;

FIG. 30 is a display of the distribution of active placements according to an aspect of the present invention;

FIG. 31 is a display of the distribution of new placements according to an aspect of the present invention;

FIG. 32 is a display of the distribution of viral hubs according to an aspect of the present invention;

FIG. 33 is a display of the unique visitors according to an aspect of the present invention;

FIG. 34 is a display of the graphical display of the visitors' geographic locations according to an aspect of the present invention;

FIG. 35 is a display of the operating systems of visitors according to an aspect of the present invention;

FIG. 36 is a display of the browser type for each visitor according to an aspect of the present invention;

FIG. 37 is a display of the browser type and operating systems for each visitor according to an aspect of the present invention;

FIG. 38 is a display of the language for each visitor according to an aspect of the present invention;

FIG. 39 is a display of loads of desktop widgets graphically displayed as a function of the day of the load according to an aspect of the present invention;

FIG. 40 is a display of the reporting on new install according to an aspect of the present invention;

FIG. 41 is a display of the reporting on active installs according to an aspect of the present invention;

FIG. 42 is a display of the reporting on unique visitors according to an aspect of the present invention;

FIG. 43 is a display of an aspect of the present invention designed to allow monetization of widgets according to an aspect of the present invention;

FIG. 44 is a display of a campaign that may be created and managed according to an aspect of the present invention;

FIG. 45 is a display designed to allow a user to edit a campaign according to an aspect of the present invention;

FIG. 46 is a display of the campaign info editing screen according to an aspect of the present invention;

FIG. 47 is a display of the widgets in campaign editing screen according to an aspect of the present invention;

FIG. 48 is a display of the high level campaign reporting according to an aspect of the present invention;

FIG. 49 is a display of the campaign reporting according to an aspect of the present invention;

FIG. 50 is a display of the widget vs. widget reporting according to an aspect of the present invention; and

FIG. 51 is a display of the monetization options according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in software, including software related to widgets and online content. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention relates to a widget, and to exemplary methods of creating, maintaining, monetizing and reporting the widget and its underlying architecture. A widget is a device that is created to run inside another piece of code, such as a webpage, wherein the device allows a user to create, such as creating website mash-ups, by embedding content or code from one site into another site or piece of code.

It is not typically necessary for a user to have extensive experience in computer programming or in web design in order to use a widget, for example. Creation and use of a widget may be as simple as cutting and pasting, which users have typically grown accustomed to. In particular, cutting and pasting may be performed to or from anywhere on the web. Widgets may be dynamic. Widgets may be live and current with the underlying content, such as within blogs and web pages, meaning that whenever the underlying content changes, so will the widget created therefrom, whether housed within a blog or webpage, for example.

Widgets may allow a user to preview the display of a widget within a webpage or blog, such as in order to maximize the level of personalization, control and simplicity, by way of non-limiting example. Widgets may mobilize the web, in that widgets are flexible and able to be used anywhere a user goes in the online world. Widgets may be customized in color, layout and text to match a user's online personality or display preference. Widgets may not require downloads, thus avoiding the dangers of spyware or adware or viruses, thereby making widgets relatively safe to use. Widgets may be free to create, use and customize.

Widgets may thus be used to enrich desktops, personal web pages and blogs, for example. Widgets may also be used to move content from one environment or webpage to another. Further, widgets may be used to take content from a desktop to a mobile phone or mobile handset, for example.

The widget API of the present invention may be broken up into two sections: the core API and the extended API. The core API may consist of code that is fundamental to the operation of a widget. Core code may be automatically included as part of the deployment of a widget, and thus may always be available to the widget. This core API may include commonly used functions and classes used manipulate the structure and content of a widget.

The extended API may consist of optional code that may be helpful in developing widgets. This code is typically not automatically included. Developers may explicitly specify which parts of the extended API are available to include within widgets.

The present invention may include brand decoration, for example. This decoration may consist of all, some, or none of the following elements: title bar; border; and base or partner logo; hyperlinks to base, API or partner website; and/or other branding elements.

Widgets may be composed of three main components—the content, style and script. The content component may be analogous to the XHTML code of a webpage. In fact, the content of a widget may be defined by XHTML code. Only tags that are legal inside the <div> tag of the XHTML spec may be usable in the content component. A widget may consist of only the content component, but the content may be static and non-interactive in such a configuration. The website http://www.w3.org/TR/xhtml1/ may be used for further information regarding the content component.

The style component may be used to describe the look and feel of the widget. The CSS style sheet language may be used to define styles. The websites http://www.w3.org/Style/CSS/ and http://www.w3.org/TR/REC-CSS2/ may provide further information on the style of a widget.

The script component may define the logic of the widget. The script component may rely on JavaScript language for code. More information on JavaScript language may be found at http://developer.mozilla.org-/en-/docs-/Core_JavaScript_{—}1.5_Reference. Widgets may also have named variables that are modifiable by end-user.

Preferences may be defined by four properties: type, which is the type of the preference; name, which is the script name of the preference that may include alpha-numeric characters (i.e. a-z, 0-9); display name, which is optionally the name of the preference displayed to the end-user; and default value, which is optionally the default value of the preference.

Thus, a widget in accordance with the present invention, and as will be understood by one of ordinary skill in the art, is a portable portion of code that may be installed or executed within any separate HTML, flash, or similar based webpage webtop, or desktop by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code to cause presentation of that selected code portion. The widget, via the embedded code portion, thereby adds non-static content, or, in some cases, static content, to the subject webpage.

A widget in accordance with the present invention may allow a user to take a discreet portion of a favored user experience on a network, such as a portion of favorite interactive information, a favorite website, or a particular application, and transport that favorite portion for use in an approved on-line experience targeted to the particular interests of that user. For example, such a widget constituting a discreet portion of a favored user experience may be applied to a desktop or web top experience to personalize such a desktop or web top experience to that particular user. Further, such widgets in the present invention may allow for transport of a favored user experience to other user experience locations, such as computing communities and/or social networking sites, in order to improve that user's experience of such other sites or network locations. Needless to say, as used herein a network or network experience is and includes an internet, intranet, extranet, telecommunications network, and any other network experience that allows for importation of the widget concept.

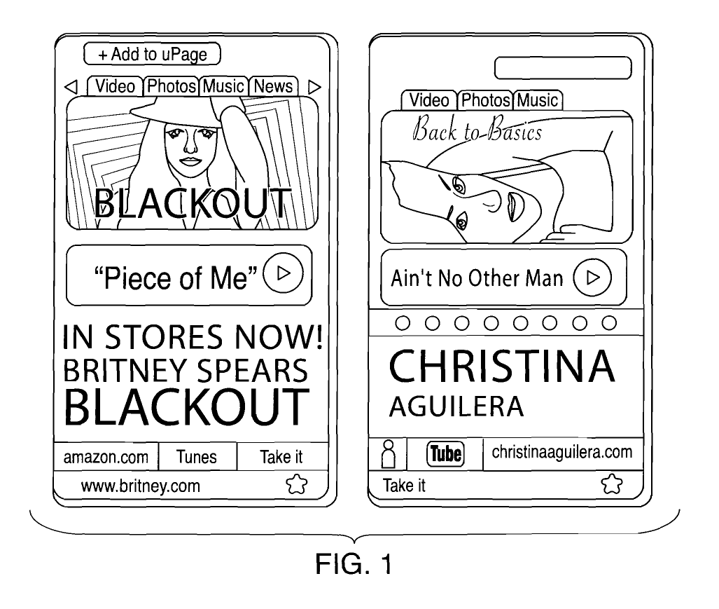

In an exemplary embodiment of the present invention, the widgets may be located by a user, or designed by a user, in accordance with preferred techniques. Such preferred techniques may include, for example, in the case of the user-defined widget, the provision of widget templates, into which a user may develop that user's own unique widgets by using discreet physical locations within such template to place code for the subject widget in an overall widget physical format provided by the template. For example, such a widget template may be divided into fields, wherein a user may be given discreet options for each portion of the field as to what widget content the user wishes the ultimate widget to have in that field. For example, the user may click on a particular field, such as the upper left quadrant of the subject widget as illustrated in FIG. 1, and may be presented with a serious of content links that are authorized for incorporation into the widget, or a dropdown menu from which the user can select authorized types of content for that portion of the widget, or a hierarchal dropdown menu from which the user can select a top level, and subsequently more specific levels of allowed content from the available authorized content. Further, the use of particular content in one portion of a widget template may limit the allowable content in other portions of the widget template. For example, once a user elects to have a quadrant of a widget themed in accordance with a particular musical artist, the template may limit the allowable artists that may be involved in other portions or quadrants of the widget template. For example, in the event that an active aspect for the overall widget is incorporated into the upper left quadrant of FIG. 1 in relation specifically to musical artist Eminem, and thereby at least a portion of the widget code relates to artist Eminem, the options available for the remainder of the widget may be limited only to those relating to musical artist Eminem: that is, for musical widget content, all of the code for the overall widget must relate to the artist Eminem. Upon design of a widget, the user may “publish” the widget to a desired location.

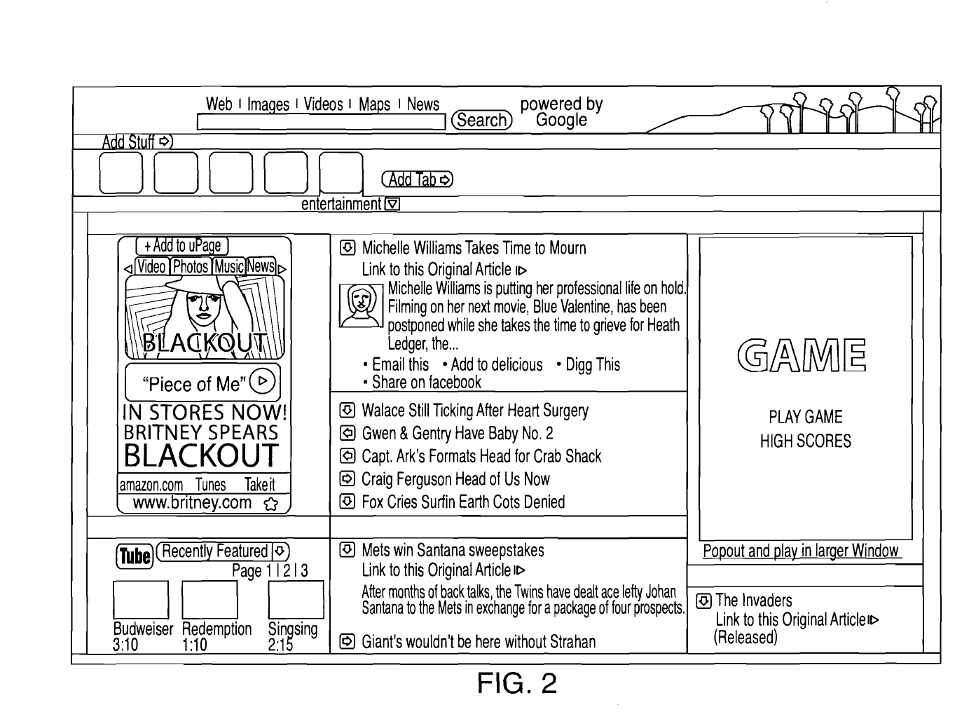

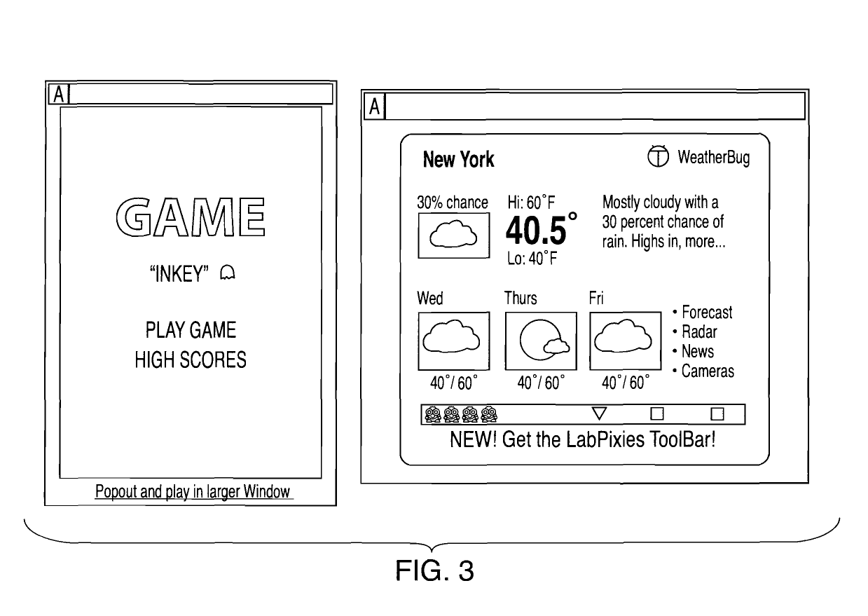

Additionally, a library of existing widgets may be designed to be made available to improve the user experience upon use of a particular web top or desktop. Such a library may be available via a particular website, via a web top application, via a desktop application, or via discreet application, for example. For example, under the assumption that rights are obtained to create widgets for placement into the library with regard to all artists operating under a particular music recording label, widgets may be designed for placement into the library for all artists recording under that music label. Similarly, widgets may be designed for interest in, or capability of, playing within the widget of particular video games, such as “antique” video games, as illustrated in FIG. 2. Other widgets that may be placed into such a library may i require no licensing to allow for creation of the widgets. For example, a weather widget, or a traffic widget, may be developed for specific geographic locations, or may be generically developed and may access the location of the user requesting the use of that particular widget, such as by the physical location of the IP address of such user, and may fill in the selected widget based on the user's geographic location, as illustrated in FIG. 3. In such examples, a weather widget may be made available with up to the minute radar, immediate forecast, projected seven day forecast, current airport conditions, road conditions, or delays, and the like. Similarly, traffic updates may be made available in a traffic widget for certain local roads, which local roads may be selectable as roads of interest to the user upon selection of the particular traffic widget from the widget library. Examples of predefined music widgets, video game widgets, and weather widgets, as discussed immediately hereinabove, are illustrated in FIG. 3.

Similarly, the present invention include a fully portable, widgetized avatar having associated therewith multiple items of information and/or social information that may be generally searched for and/or otherwise requested for association with at least two different computing communities or transactions. Widgetization of the avatar of the present invention necessarily allows for portability of the avatar of the present invention. For example, widgetization of a typical avatar in accordance with the present invention may include the association of physical, such as facial and hair, features with the subject avatar, as well a user name. Further, a myriad of additional information may be associated with the avatar, wherein such information is generally required or desired for use in computing communities or transactions, such as search transactions. This information may be organized into multiple levels of detail and/or multiple levels of accessibility to third parties in a computing community or transaction. Such levels of accessibility may be selected by the creator of the widgetized avatar, and may be based on characteristics of the third party endeavoring to access the subject avatar. For example, a user may have basic information, which may be selectable for viewing by all registered users.

In an exemplary embodiment, a user may have likes or dislikes, such as musical or motion picture tastes, job or educational status, age, location, income, marital status, and other computed communities with which that user is associated, associated with his or her avatar, and each such like or dislike may have associated therewith a widget code portion.

The present invention may provide a physical manifestation of all of this information, such as in a “trading card” format widget. For example, the front of the virtual trading card may include an avatar having particular physical features, clothing, accessories, activities, likes, dislikes and expertise, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

It will be apparent to those skilled in the art that providing a widget library to users will provide to the user great flexibility in improving the users' experience of the web top, desktop, or other network experience into which the user incorporates such widgets. In order to provide further flexibility and ease of user experience, such a widget library may be made available to the user in a format that will allow the user to readily locate a widget, widget portions or widgets of interest. For example, a widget directory, such as a hierarchal widget directory, may be provided in accordance with the present invention, and such directory may further be provided with an interface that allows for successive level searching assisting users in finding and adding widgets or widget portions of interest to improve the user's experience. For example, a user may be enabled to search by any one or more of known methods for a widget or widget portion of interest, or all widgets related to a topic of interest, such as by searching alphabetically, by key word, by topical area, and the like, and upon selection of any widget category that the user has sought, the user may be provided with widgets falling into that category, or the user may be provided with an additional set of selectable variables that will allow the widget entities within the library to be further narrowed before presentation to the user for choice by the user.

Additionally, such a user searching feature may include wish lists, hot topics, or collections that may be developed or entered by the user, in which the user may request alerts when desired widgets or widget portions are available, the user may request alerts to the availability of other widgets in another topical area of interest, or the user may wish to aggregate widgets by interest group, or topical keyword, so that the user may have ease of creating and publishing, or downloading, or otherwise accessing in large quantities.

It is desirable, in accordance with the present invention, and in order to best improve the user experience, to allow for third party content providers to employ an interface or one or more templates to create widgets that they believe their users, listeners, viewers, or fans would most like to download in order to improve the user experience. Thus, the present invention may include a widget creation and/or upload tool, whereby a third party may be provided with one or more templates from which that third party may create a widget. For example, the third party may wish for inclusion of particular audio, video, or audio visual works in a widget directed to the fans of that particular third party. Further, the third party may make available particular still commentaries or critiques, press releases or reviews, caricatures or parodies, logos or technologies and/or research, or requests for information and/or partners, as part of that third party's widget design. Needless to say, third parties may create multiple widgets in order to target multiple users for fans of that third party having different interests.

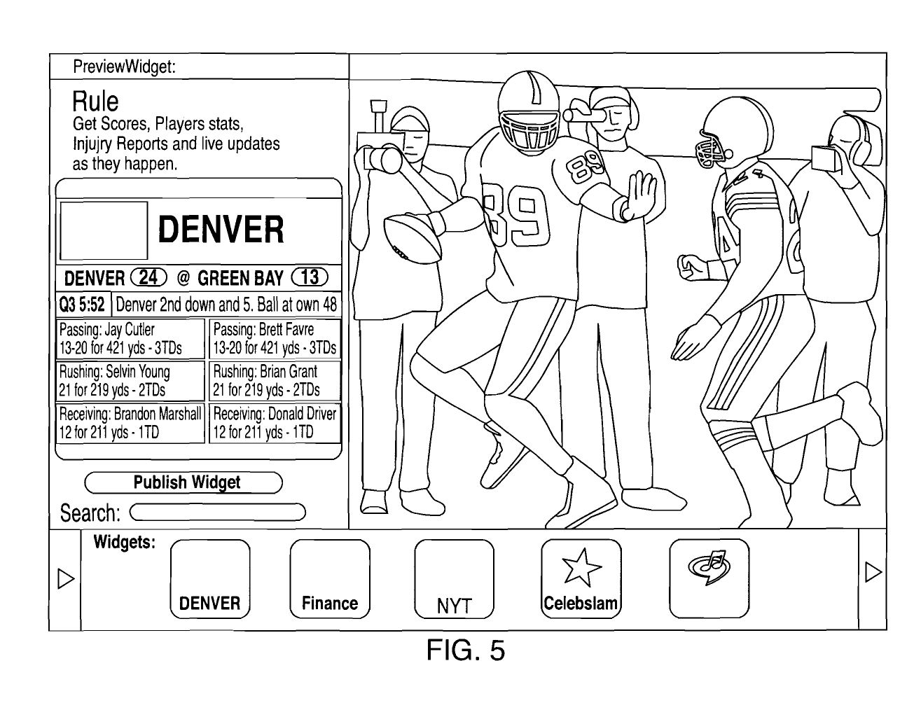

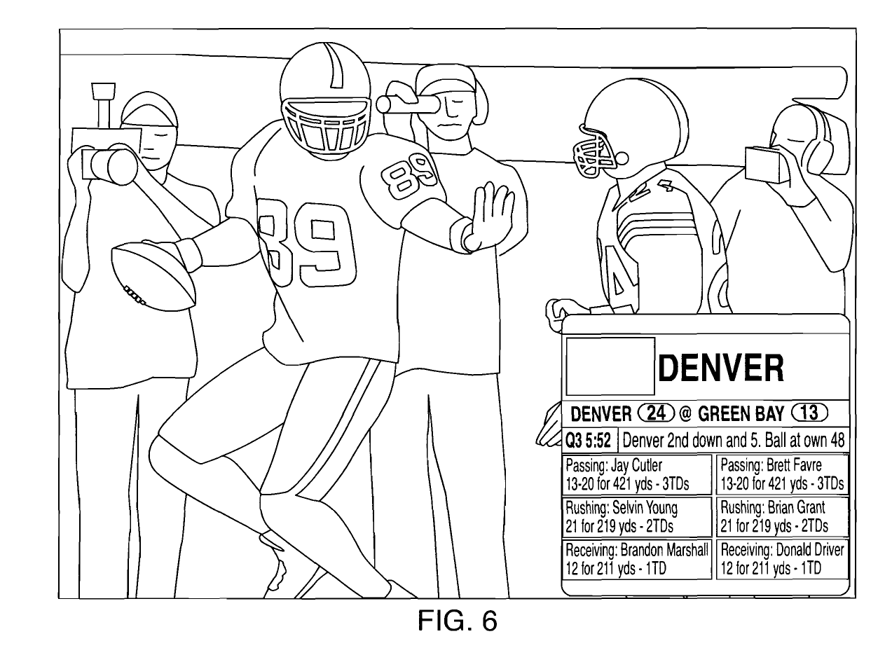

Further, for example, widgets may be combination of third party published widgets and user designed widgets. For example, FIG. 5 illustrates a widget used in a television or DVR computing community. In the illustrated embodiment, numerous widgets or widget templates may be made available, such as for selection from a menu. In the illustrated embodiment, a National Football League widget is made available, and is selected by the user for publication. The user may select what scores, statistics, or the like are to be included in the widget upon publication. As illustrated, other widgets may be available to the user, as may be a widget search mechanism as described herein. FIG. 6 illustrates that the subject widget may be published into an active program. As is typically the case with widgets, the widget code need not be compiled, and thus may run simultaneously with the program code of the illustrated football program. For example, such as through the use of a metadata stream corresponded to the television program, the widget may be overlayed on the screen. Thereby, a viewer of one television program may select a widget that may provide information about other matters not then being viewed by the program viewer. Thus, for example, a user can track fantasy sports information while watching a sporting event, may track news while watching a sitcom, or the like.

Through the use of the present invention, widgets may be tracked. For example, widgets of the present invention may be associated with a cached identification, which is matched to the and as such each time the widget is dragged and dropped downloaded, or otherwise moved and/or used in a user's desired location, such as a web top, the movement and/or download of the widget is tracked. As such, information with regard to the party's dragging and dropping the widget, or the point to point locations from which a widget is dragged and dropped each time that widget is dragged and dropped, may be tracked by tracking of the associated cached identification. As such, particular metrics, such as Google® metrics, may be associated with each widget, and the use of each widget. Such tracking information may be provided, such as to the publisher, i.e., the third party creator, of a particular widget, in order that the publisher may be enabled to make an accounting for the use and/or download of the widget. Thereby, payment methodologies may be associated with the use and/or download of the widget.

Additionally, for example, as will be understood by those skilled in the art in light of the discussion herein, in embodiments wherein the certain characteristics of a user are known to the search engine of the present invention, the downloading of widgets in accordance with the present invention allows for a monitoring of who performed a search, what they deemed most relevant responsive to it, and what was done responsive to that relevance, such as the downloading of a widget. Thus, again, the present invention may include an advanced marketing and sales tool.

Further, discretely or in association with the aforementioned tracking of widgets, the use of particular widgets may allow for assumptions with regard to the interest of the downloading user of the subject widget. Thereby, monetization, such as advertising monetization, may be associated with the user of the subject widget, such as by allowing for the presentation to the user of particular advertisements, such as from an advertising server, based on the user's use or download a particular widget. Further such advertising may be directly associated by the publisher of the subject widget for presentation to the user of the subject widget at predetermined times, or upon predetermined uses of the subject widget. For example, a publisher, i.e., a third party creator, of a subject widget may determine that an advertisement related to that publisher is displayed to a user at least once per week following the downloading by that user of a widget associated with that publisher.

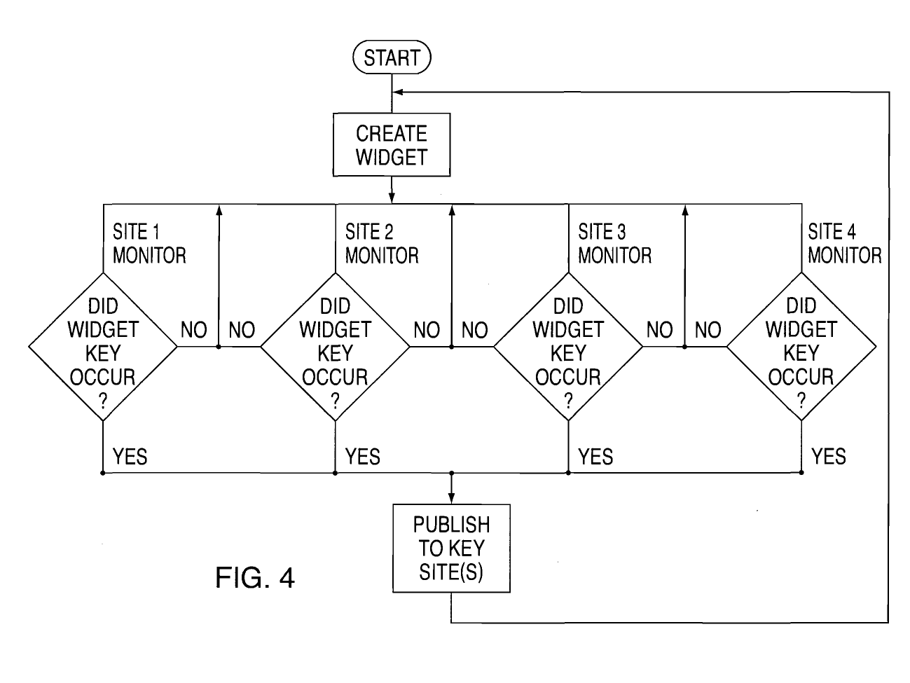

The present invention may further include a widget aggregator. Such a widget aggregator is illustrated in the flow diagram of FIG. 4. The widget aggregator may, upon publishing of a particular widget, allow for selection by the publisher of a myriad of keys that, upon occurrence of those keys in any location within the aggregated universe selected by the publisher, will cause publication, use, and/or download of the select widget into the particular location. For example, the aggregator may allow for the publisher to request publication of the subject widget into one or more of multiple travel-related internet sites, such as Expedia.com or Travelocity.com, upon occurrence of one or more circumstances in relation to a user of those travel sites. Thereby, the present invention eliminates the necessity of a design of a widget for each desired publication site for a widget, such as in the instance where the desired universe of sites may be quite large.

In order to increase the ease of use, among other reasons, a widget for creation engine is included in the present invention. Using this widget creation engine, stationary or mobile content may be created. In the widget creation engine there may be steps to view, customize, mashup, and get, the underlying widget.

In viewing the widget, the present invention may provide tools to preview the layout of the underlying widget, such as on a blog or personal webpage. This may be accomplished by entering login information as necessary, and/or by choosing widget and/or creation settings and clicking preview.

To customize a widget, the present invention may provide the ability to customize fonts, colors and size of the widget, for example, such as to match the blog or webpage into which the widget may be inserted. Specifically, the user may select a font, text size, and color/pattern, and may customize the height and width of the widget, such as by dragging and dropping the bottom right corner of the preview window, for example.

In a “get” widget creation, widget may be realized into the blog or website. This may be performed, for example, by copying or cutting the widget code and pasting the code into the desired blog or webpage, for example.

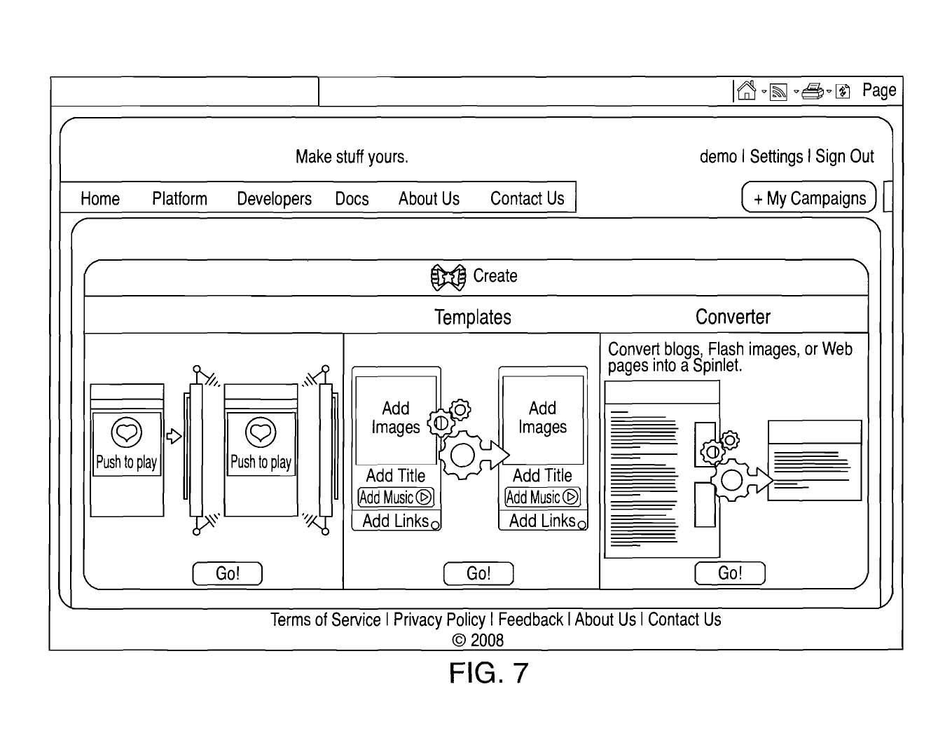

Creation of widgets using the widget creation engine may be performed through a creation wizard. As may be seen in FIG. 7, and according to an aspect of the present invention, the present invention may create using a “widgetizer,” a template and/or a converter. According to an aspect of the present invention, creation of widgets may allow a user to easily create, distribute, manage, report and monetize widgets through an open widget creation engine and platform.

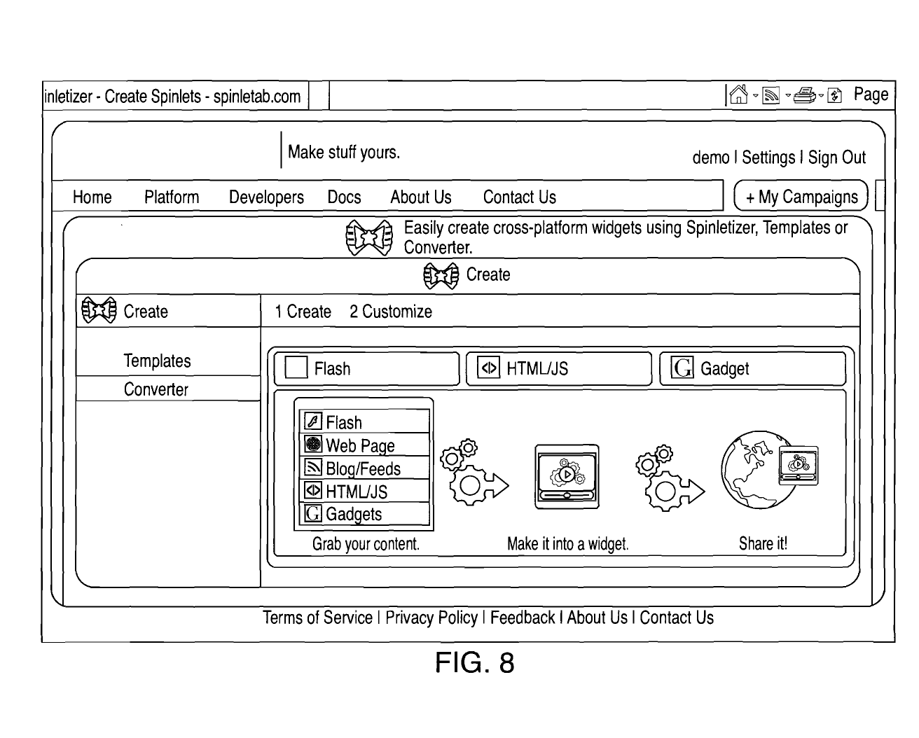

The widgetizer may be used to widgetize an existing item or code element. As may be seen in FIG. 8, the widgetizer may be configured to grab content, make the content into a widget and enable sharing of the widget. According to an aspect of the present invention, a widget, such as that created using or associated with the widgetizer, may be created to capture live video, including television, and audio, including radio. The present widget may thus also include, for users, the ability to watch, control, record, edit and share the content captured and streamed through the present widget. This capturing may include any type of audio, video, pictorial, graphical, or data broadcast.

The present invention may thus include a widget that has the capability to directly capture any or a limited subset of, broadcasts. As may be understood by those possessing an ordinary skill in the pertinent arts, the aforementioned direct capturing may require an antenna, satellite dish, or other receiving device. Further, the widget may require a deconverter, such as a settop box, and/or a tuner, such as a dial tuner for a radio, for example. Other types of signal preparation devices may also be used, such as descramblers and filters, as needed to decode the signal for display.

The present invention may also indirectly capture broadcasts. This may occur by remotely operating and controlling another device or devices, which device or devices are capable of receiving/descrambling/decoding, as necessary, a broadcast. This may occur by remotely controlling a radio, settop box, DVR, VCR, DVD player or television, for example. The widget of the present invention may include communications connective to a settop box, for example. These remote communications may take the form of software inherent in the widget that allow a user to control the local device associated with the widget, such as a settop box, for example. This control may include the ability to select channels (of the incoming broadcast), view and select recorded programs, and set programs to be recorded, for example.

In such a configuration, the widget of the present invention may provide access and viewing of a remote broadcast. This may occur by redirecting an input to a single computer which may either be located on a local network or remotely, for example. This is referred to in the pertinent arts as place shifting because the broadcast may be viewed in a place other than where the broadcast is received.

The present widget may provide access and control of the local device either through an internet connection, infrared connection, or other mechanism. The widget of the present invention, located on the Internet or on a mobile device, for example, may connect remotely to the local device and provide the user an interface for viewing the video or audio stream, and may also provide for the control of such stream, such as by providing the ability to change channels or select recorded media, for example. Onscreen virtual remote controls may additionally be provided for controlling connected devices.

The present widget may include a live video or audio buffer to pause, fast-forward, and rewind, such as by buffering up to sixty minutes of live video, an integrated channel/program guide, and a web-based account to assist in finding and connecting to the local device via the internet or mobile device. The present widget may allow users to share clips of broadcast, such as television shows, for example, with other users through the web, for example. Such sharing may be provided within the widget of the present invention and may take the form of a hosted web-based service. The present widget may also be used in a circular type recordings, such as would be necessary for continuously capturing feeds from security cameras or media monitoring, for example. In such a configuration, the widget of the present invention may provide a remote monitor of the feeds from security camera and media monitoring. The widget of the present system may also be configured to provide observations of remote locations, such as by providing information on traffic and weather conditions, such as by using a remote broadcasting device such as using EV-DO via a cellular network (mobile phone) provider.

Additionally, the present invention may be used to time shift steaming video. As set forth above with respect to place shifting, time shifting may include a multifunctional widget that streams live or recorded video, such as television broadcasts, including digital cable and satellite, or audio, as well as DVDs and DVR content over a home network or the internet. The present widget may thereby be a remote video streaming server.

The widgets of the present invention may connect, for example, to a home network via wire or wirelessly, such as to stream content through the network to a local content device, or across the internet to remote devices. As may understood by those possessing an ordinary skill in the pertinent arts, there is no technological reason that this connection may not be made as a one to many, such as to allow many users to watch the same streaming broadcast. Because of certain legal constraints, the widget of the present invention may be limited to operate to provide streaming feeds to only a single recipient at a time. A user may thus access and control, from anywhere in the world, any device connected to the present widget, and/or switch between multiple devices.

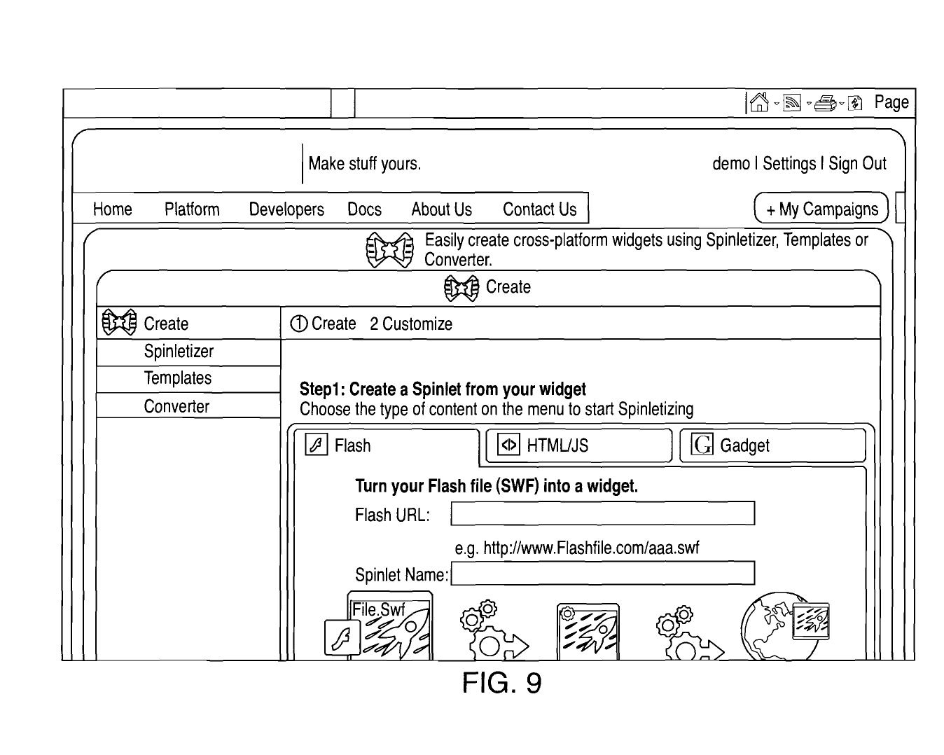

Specifically, the widgetizer may operate to turn a flash file into a widget, for example. Such a flash file may be denominated as a .SWF file, for example. As may be seen in FIG. 9, a flash URL may be input into the widgetizer and a widget name may be provided and/or assigned.

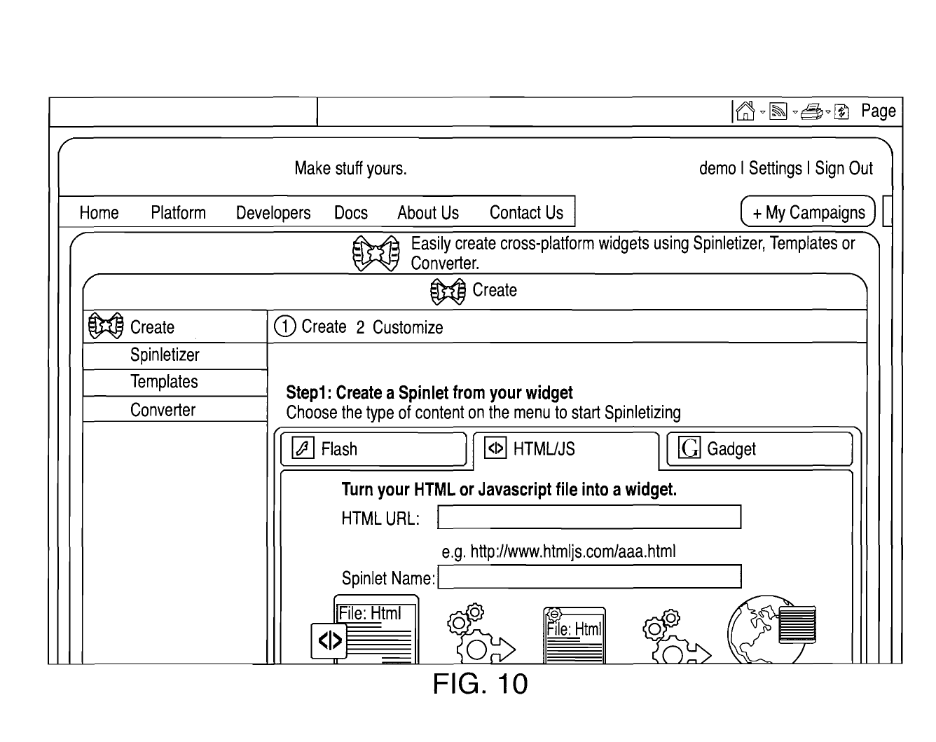

Additionally, the widgetizer may operate to turn a HTML or JavaScript file into a widget. Such a HTML/JS file may be denominated as an .HTML, for example. As may be seen in FIG. 10, a HTML/JS URL may be input into the widgetizer and a widget name may be provided.

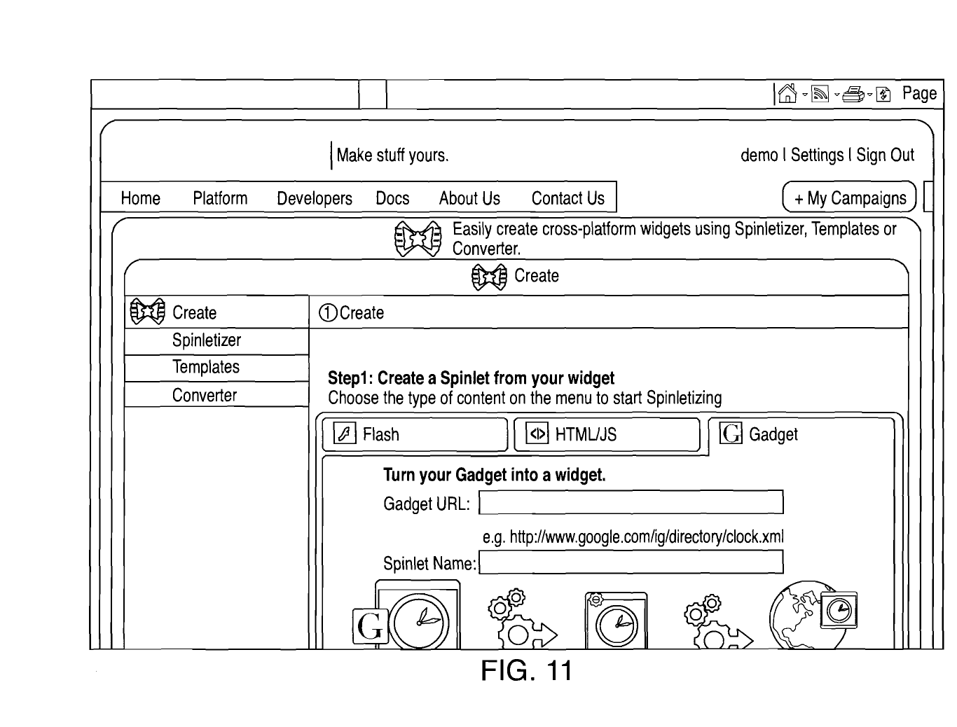

Additionally, the widgetizer may operate to turn a gadget into a widget. Such a gadget may be denominated as an .XML, for example. As may be seen in FIG. 11, a gadget may be input into the widgetizer and a name may be provided.

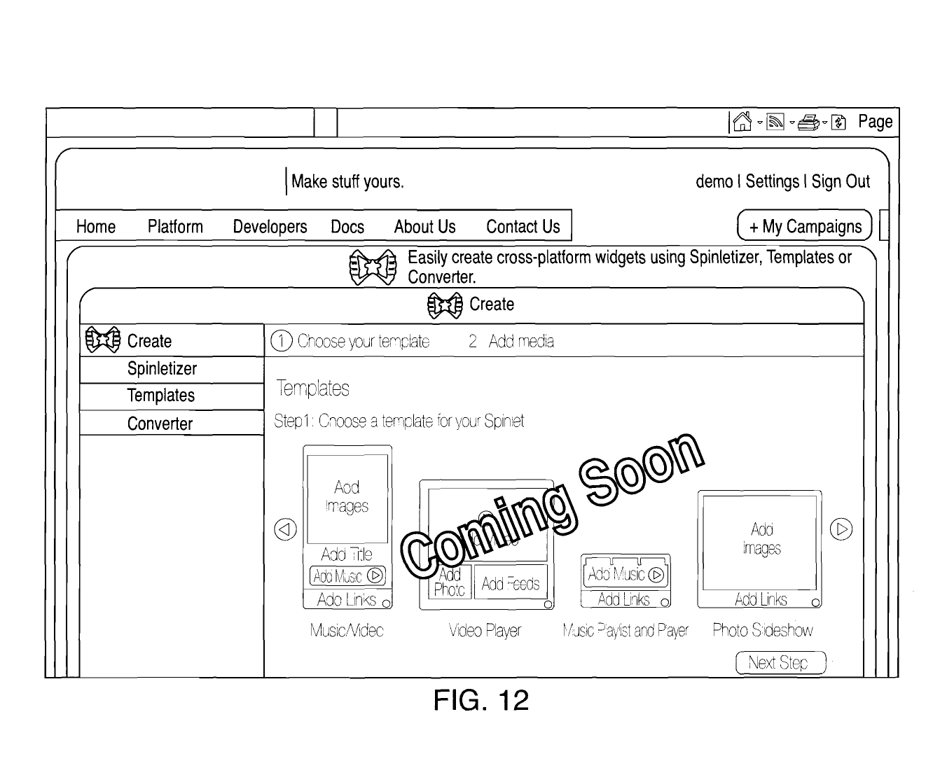

The template may take the form of a standardized file type used by computer software as a pre-formatted example on which to base other files. These templates may take the form of music/video, video player, music playlist and player, photo slideshow and the like, as may be seen in FIG. 12, for example.

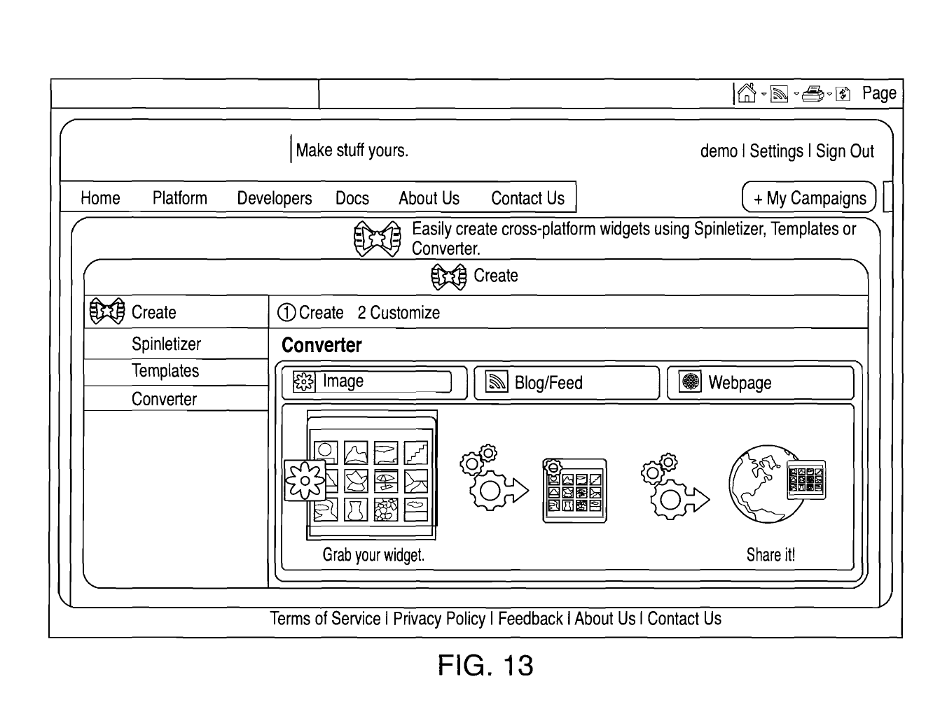

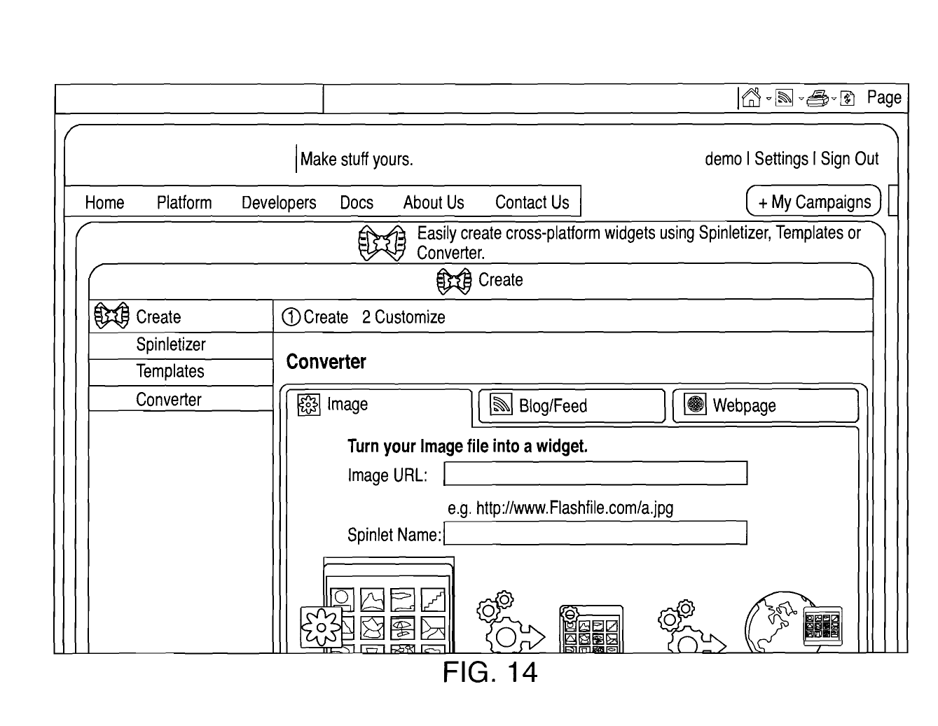

The converter may be used to convert existing content into a widget. As may be seen in FIG. 13, the converter may be configured to grab content, make the content into a widget and share the widget. Specifically, the converter may operate to turn an image file into a widget. Such an image file may be denominated as a .JPG file, for example. As may be seen in FIG. 14, an image or image URL may be input into the converter and a widget name may be provided.

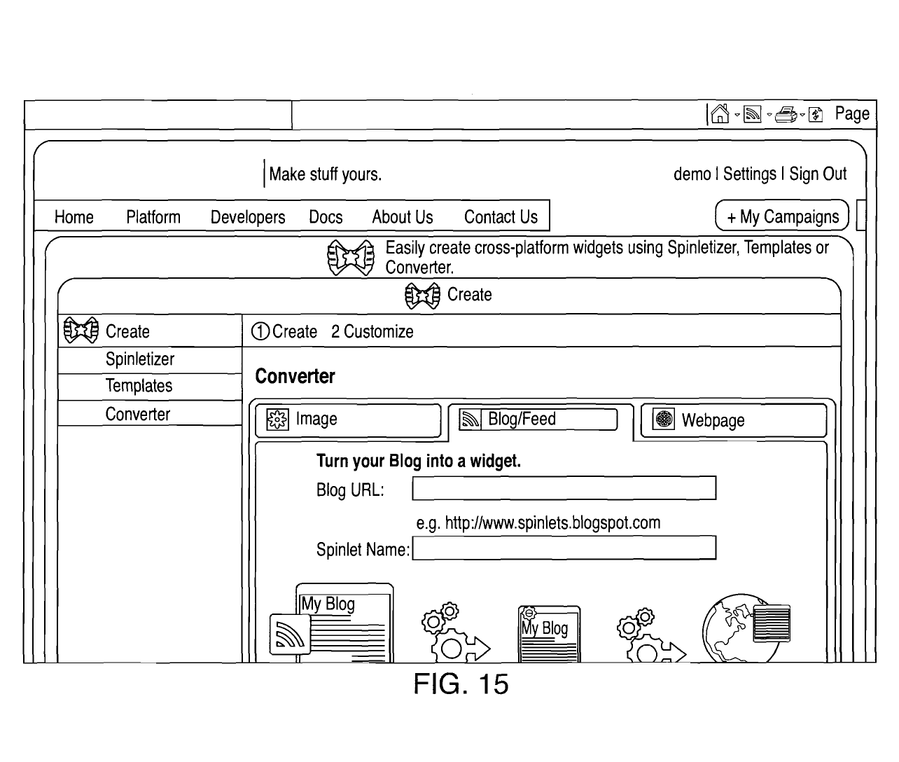

Additionally, the converter may operate to turn a blog or feed into a widget. Such a blog or feed file may be denominated as a .COM, for example. As may be seen in FIG. 15, a blog or feed URL may be input into the converter and a widget name may be provided.

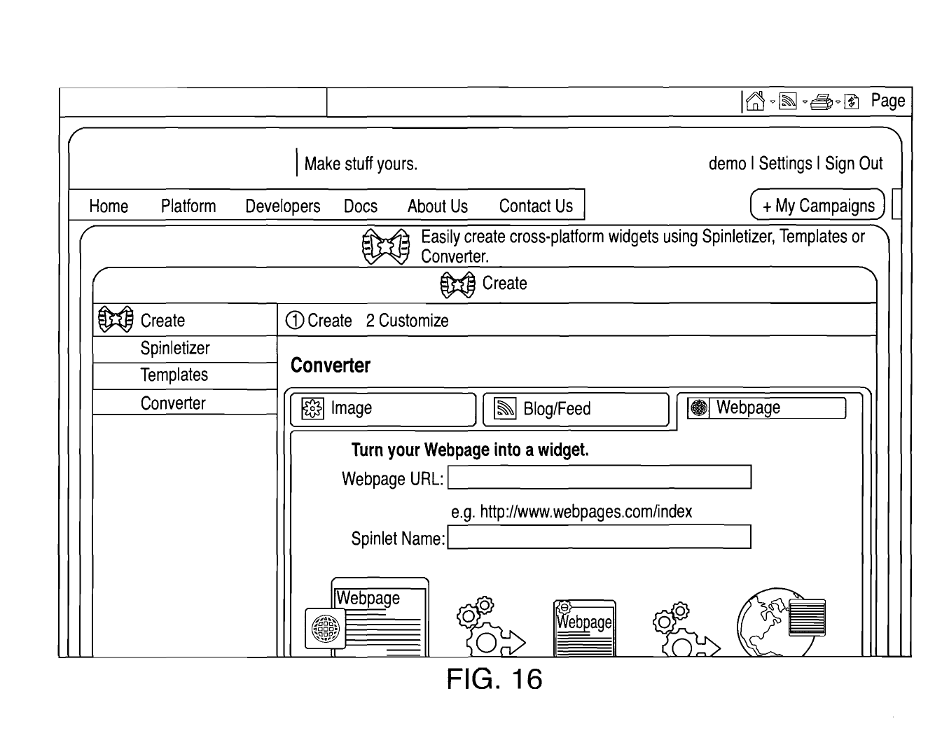

Additionally, the converter may operate to turn a webpage into a widget. Such a webpage may be denominated as a URL, for example. As may be seen in FIG. 16, a webpage URL may be input into the converter and a name may be provided.

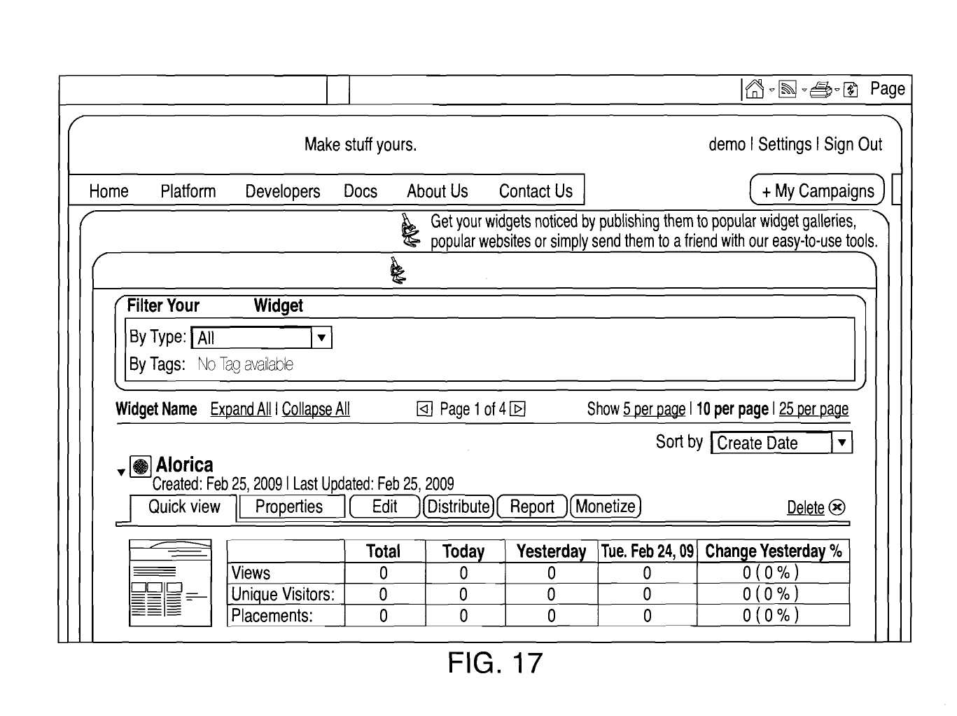

In addition to creating widgets, created widgets may also be managed using the widget creation engine and platform. Referring now to FIG. 17, resources may be available to publish widgets to galleries or websites, or to send them via email. Widgets may be managed and organized, as well as displayed and filtered according to widget attributes. Views of a given widget may be reviewed and analyzed. The total view may be viewed and displayed, such as side-by-side with views today and views yesterday, as well as views two days ago, by way of non-limiting example. This view comparison may also be shown by a percent change. A set of widgets may also be managed, and may thus include manageable characteristics, such as the date the widget is created.

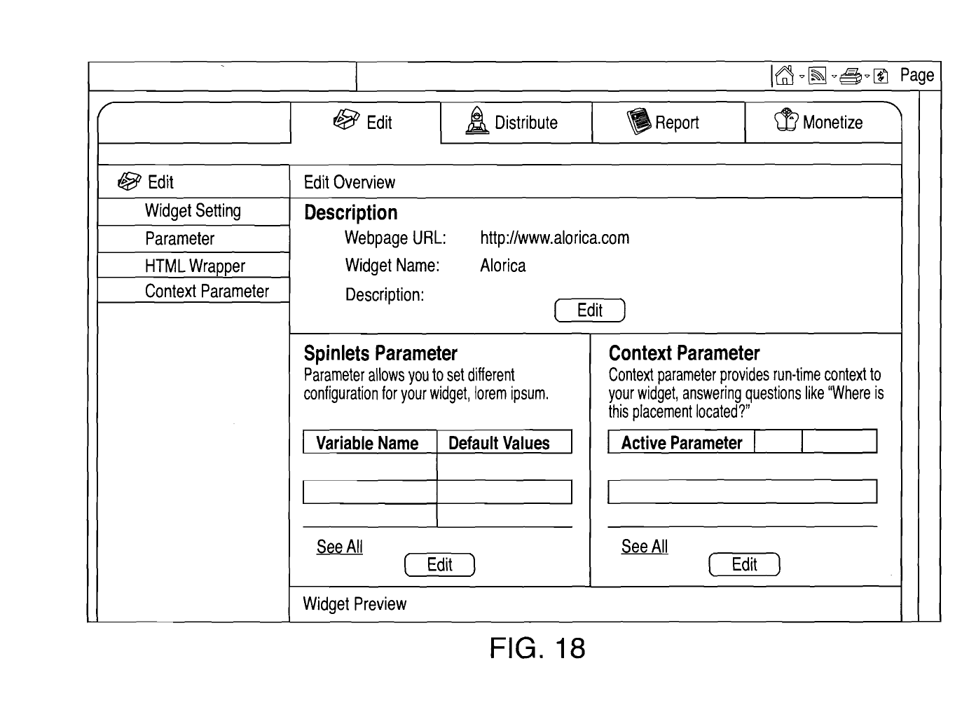

Referring to FIG. 18, a widget may be edited. According to an aspect of the present invention, the present FIG. 18 shows a widget created from a webpage URL, for example. As may be further seen on FIG. 18, the widgets parameter may be modified in order to set different configuration for the widget. A widget preview may also be displayed, as is shown in the edge of the FIG. 18. Further, the context parameter of the widget may be edited. The context parameter may provide run-time context for the widget, including such information as the location of the widget when run or initiated. Further, the widget setting may be viewed and edited, as well as the HTML wrapper.

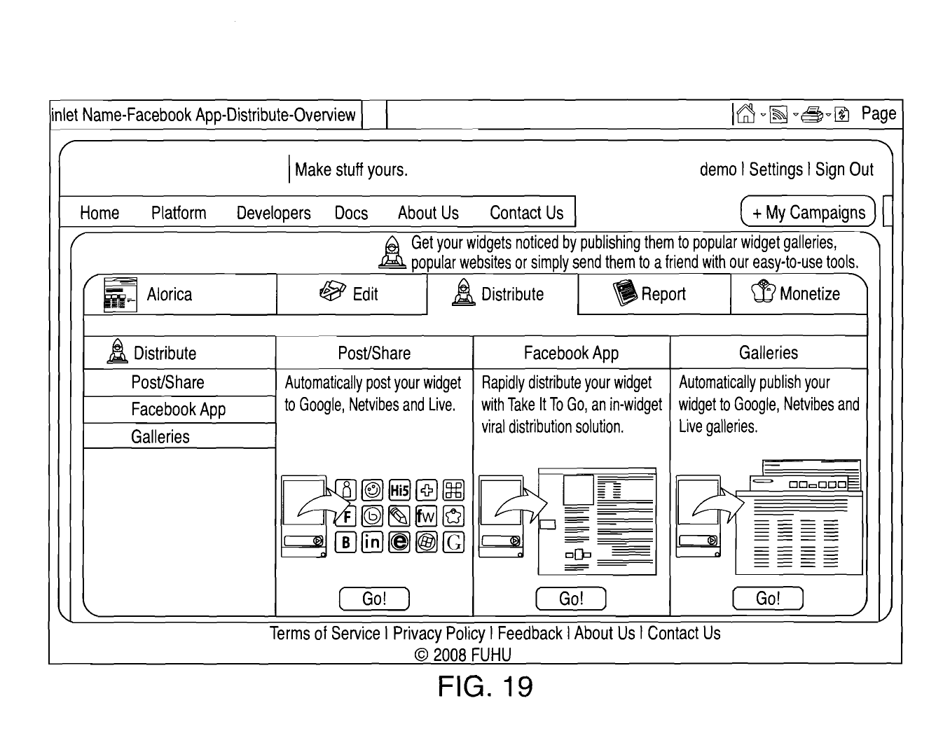

Referring now to FIG. 19, there is shown methodologies of the present invention that allow for the distribution of widgets. The present includes a myriad of ways to distribute widgets. Distribution of widgets may allow widgets to become viral, and the creation and distribution engine of the present invention may thereby increase distribution from a website, and/or publish widgets to popular widget galleries, like iGoogle.

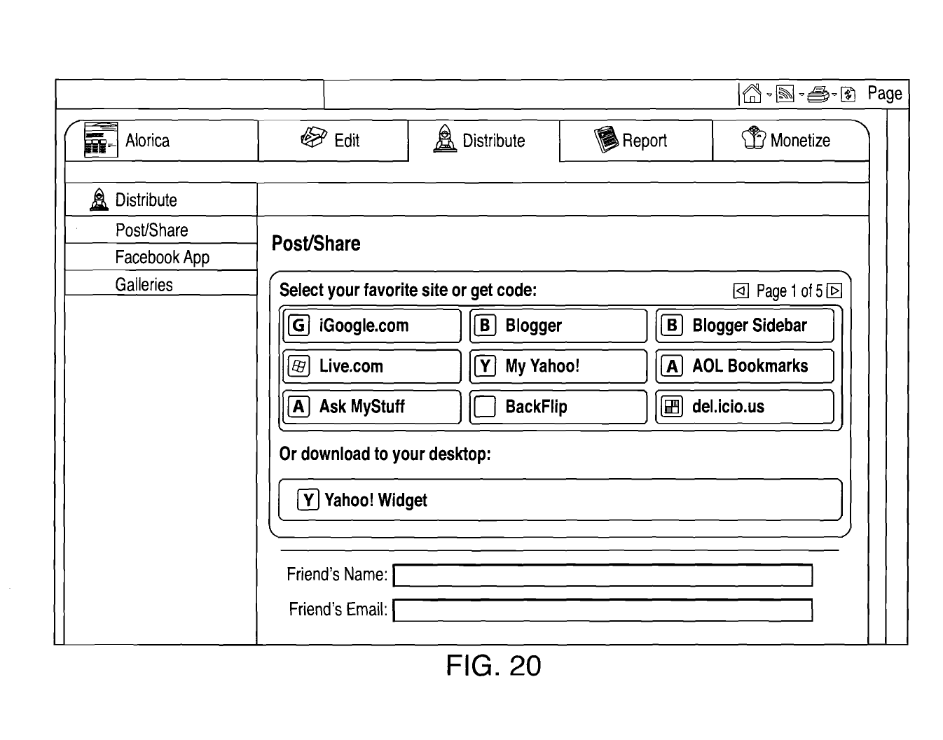

As may be seen in FIG. 19, the present invention provides methodologies for post/share, face book and galleries. Once the distribution methodology is selected, the present invention may be activated into that distribution mode. Referring now to FIG. 20, the post/share methodology may be employed to distribute the widget according to an aspect of the present invention. In an exemplary embodiment, the present post/shore mechanism may include iGoogle.com, Blogger, Blogger Sidebar, Live.com, My Yahoo!, AOL Bookmarks, Ask MyStuff, BackFlip, del.icio.us, Digg, Diigo, DropJack, Eons, Faves, Furl, Google Bookmarks, Linkagogo, Live Favorites, Mister Wong, NetVibes, Newsvine, PageFlakes, Piczo, Propeller, Reddit, Segnalo, Simpy, Skimbit, SlashDot, Spur!, StumbleUpon, Technorati, Twitter, TypePad, TypePad Sidebar, Webwag, Yahoo! Bookmarks, and Get Code, by way of non-limiting example only. Further, the present distribution also may enable downloading directly to a desktop or webtop. Further, widgets may be sent directly via email, such as by entering the name and email of a “friend” into the post/share widget, and instructing the present system to deliver the widget.

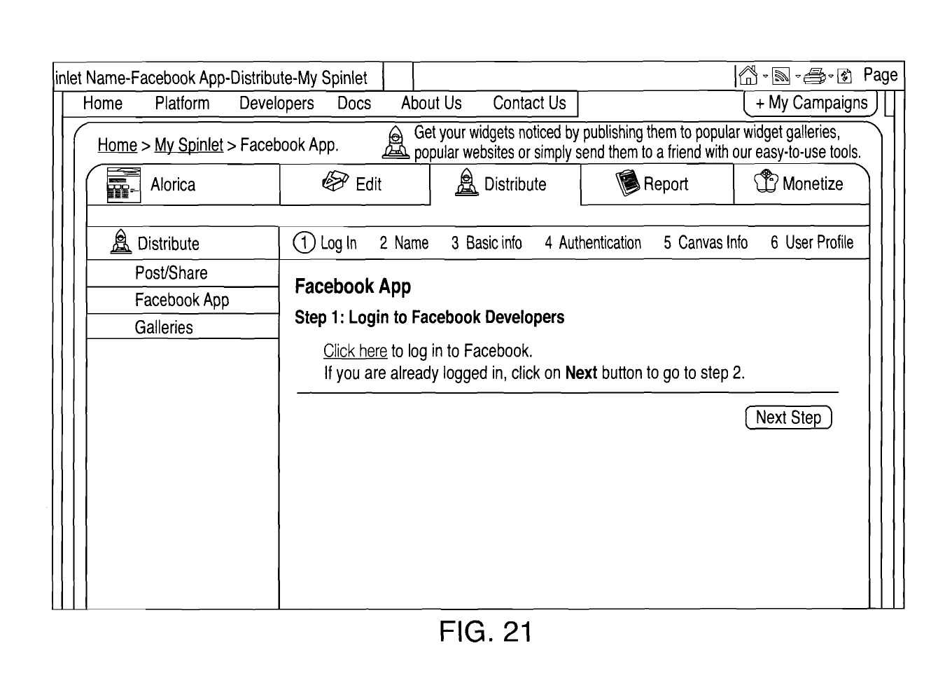

The present invention also may provide for distribution to a face book page or to the face book application, for example. Referring now to FIG. 21, there is shown the publishing and distributing of a widget to a face book page. A user may log into the face book application and then move through distribution of the widget to the face book application.

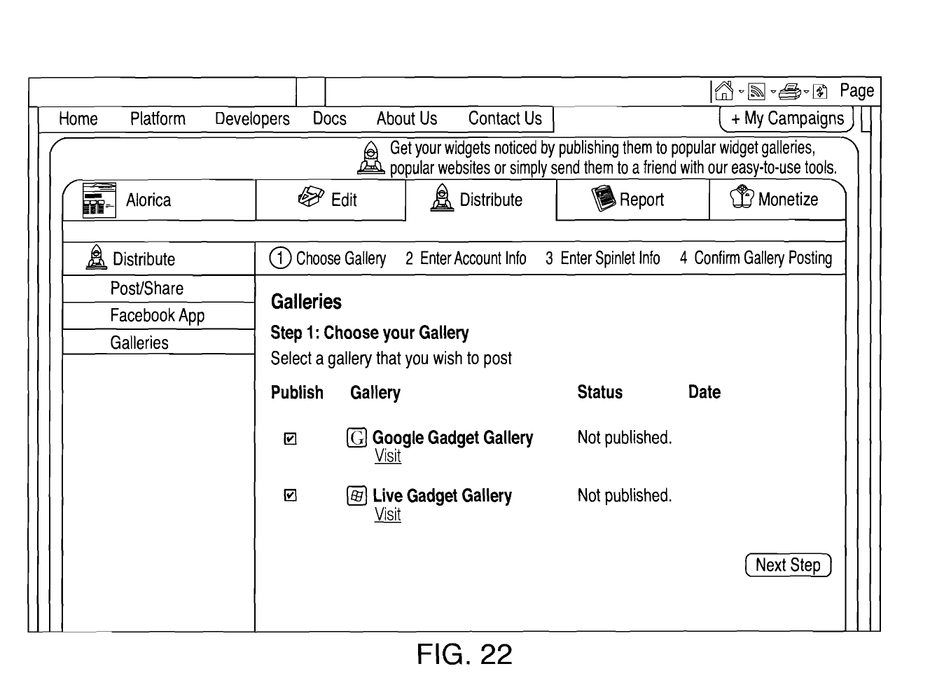

Further, according to an aspect of the present invention, and as shown in FIG. 22, distribution may be performed using a gallery to post the widget. For example, Google gadget gallery or live gadget gallery may be used, by way of non-limiting example only. If distribution is selected via galleries, the widget engine of the present invention may be used to post the widget to the gallery site.

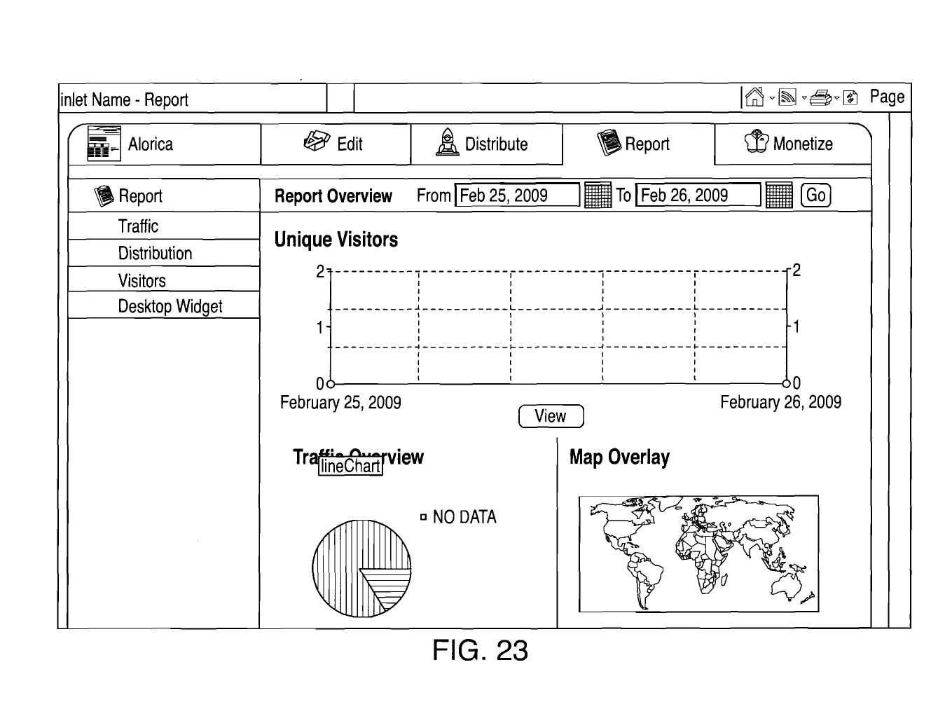

Referring now to FIG. 23, there are shown methodologies of reporting according to an aspect of the present invention. Reporting and analysis may allow widget creators to understand how widgets are being used across the web using an analytics aspect of the widget engine. A user may monitor views, placements, spread or define and track events, for example. As may be seen in FIG. 23, reporting may take the form of viewing traffic, distribution, visitors and desktop widgets, for example. A report overview may be seen, wherein the report overview provides information regarding unique visitors to the widget, traffic overview of the widget, and/or a map overlay displaying graphically the location of widget visitors. This display may be configured to show information selected from within a given date range, over the lifetime of the widget, or during a single selected day. The unique visitors may be displayed as a graphical chart, such as with the number of unique visitors shown for a given day. The unique visitors tracking enables users to calculate how many people visit a widget on a weekly basis, for example. The traffic overview provides a graph that calculates how much traffic the widget generates. This presentation may include a graphical display of a pie chart according to an aspect of the present invention. Further, the map overlay demonstrates use of the widget worldwide. This graphical display, as shown, may be a two dimensional depiction of the world with overlayed hot spots. As may be evident to those skilled in the pertinent arts, a single country, region, city, continent, or the like may also be displayed.

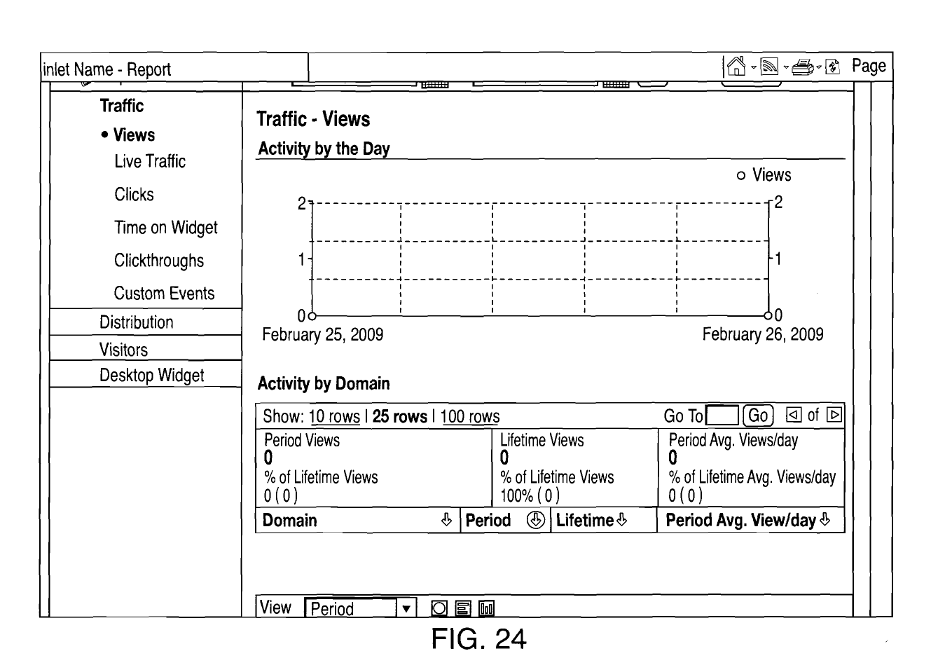

Selection of the traffic display may provide more detailed information regarding the live traffic, clicks, time on the widget, clickthroughs and custom events associated with the widget, for example. Specifically, referring to FIG. 24, there are shown traffic views according to an aspect of the present invention. As may be seen in FIG. 24, traffic views may demonstrate the activity, by day, with respect to the selected widget. Again, this traffic view may be graphically displayed with the number of hits shown on the y-axis and the date of the hits shown in the x-axis, for example. Activity by domain may also be displayed. This may demonstrate differences in period views, lifetime views and period average views per day. A pie chart display may also be used to show the number of views per period or other selectable timeframe.

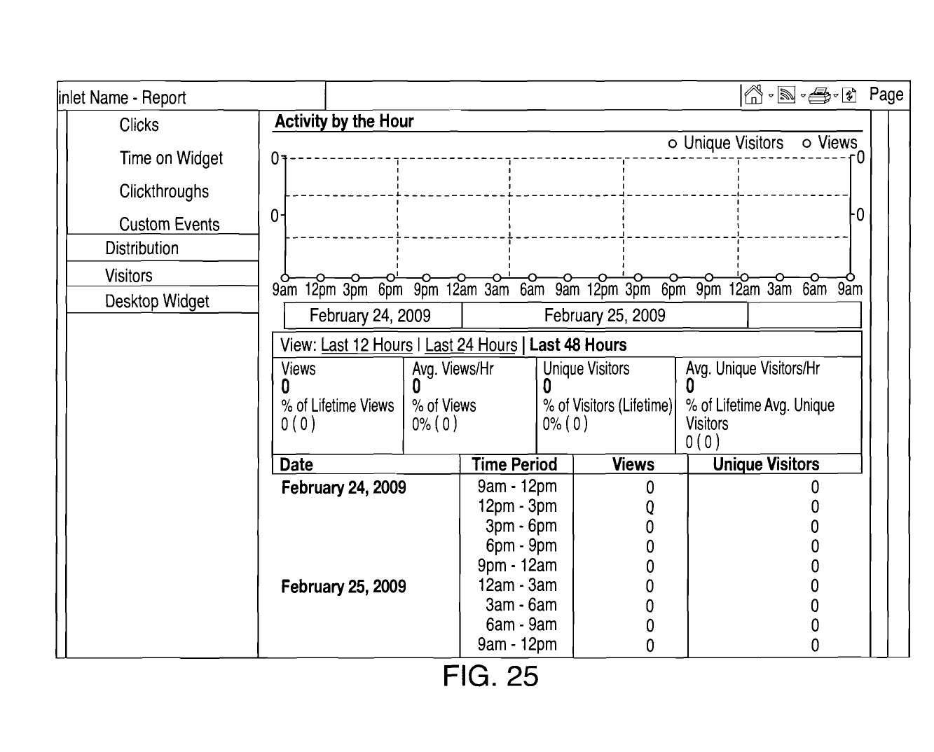

Live traffic may also be selected to provide a more detailed view of traffic. According to an aspect of the present invention, live traffic may be displayed as is shown in FIG. 25, for example. In such a display the views may be shown as a date and time with associated views and unique visitors each displayed as a summed number, for example.

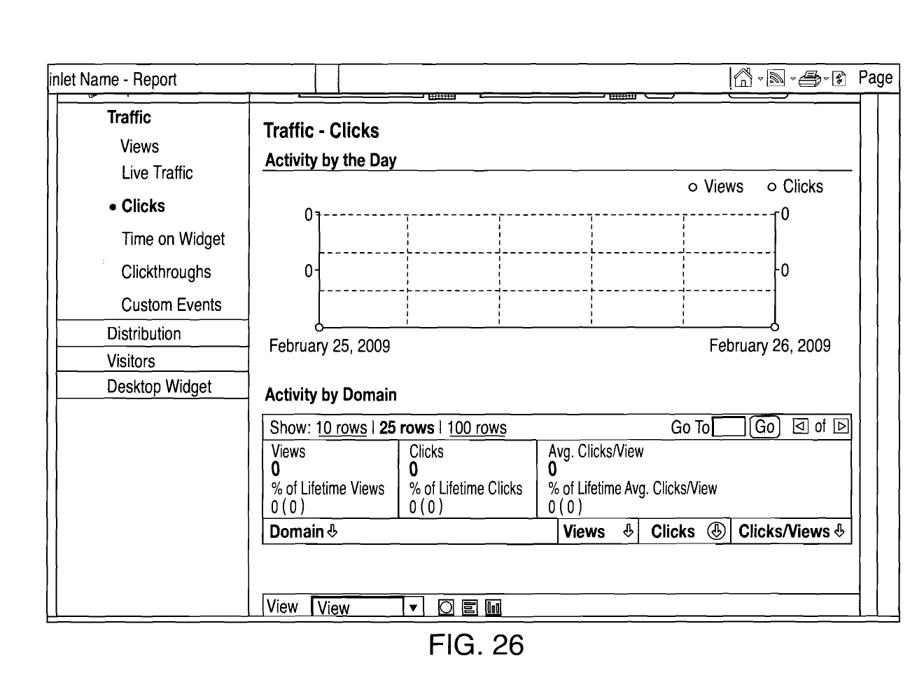

Referring now to FIG. 26, there is shown a display of traffic-monitoring using the number of clicks. As is shown in FIG. 26, the number of clicks of the widget maybe displayed as a plot of the day with the number of clicks shown on the y-axis and the respective day on the x-axis. The number of clicks may also be viewed by domain as discussed hereinabove.

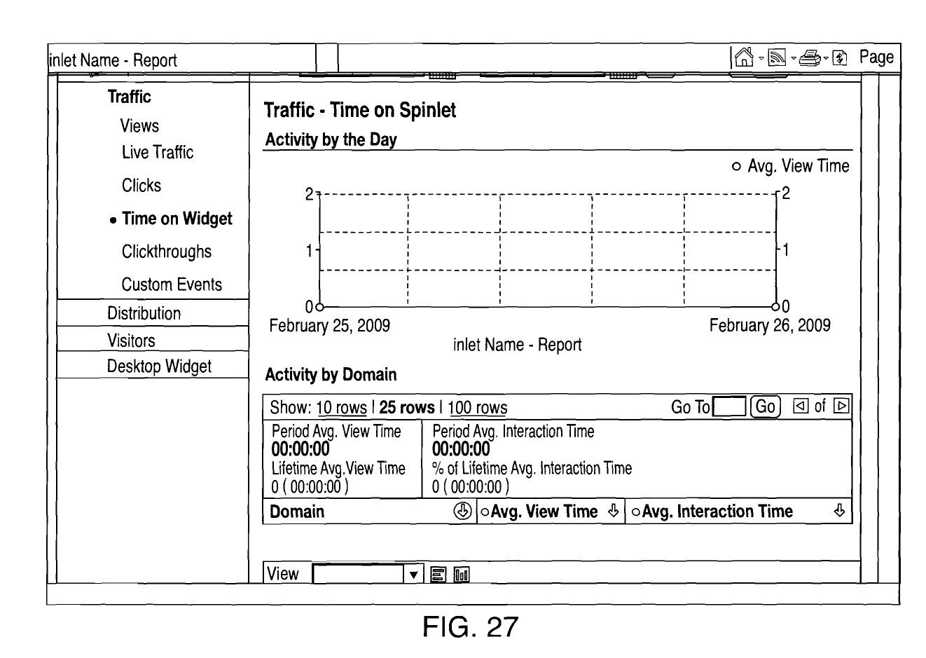

Often, the number of clicks or the visitors to a widget does not provide the necessary metrics for determining the value of an underlying widget. In such cases, it may be desirous to know the time that a visitor spends on a given widget. Often, advertising and other types of pay services may be more interested in the amount of time that a potential viewer is a potential viewer than just that a potential viewer existed. In such a situation, the display using the “time on” the widget as may be seen in FIG. 27, may provide useful information. As may be seen in FIG. 27, time on the widget may be displayed as a function of the day, by way of non-limiting example. This may provide an average view time per viewer of the widget. Once again, the domain information may also be displayed such that the view time per domain may be shown. This may include period average view time and period average interaction time, by domain, for example.

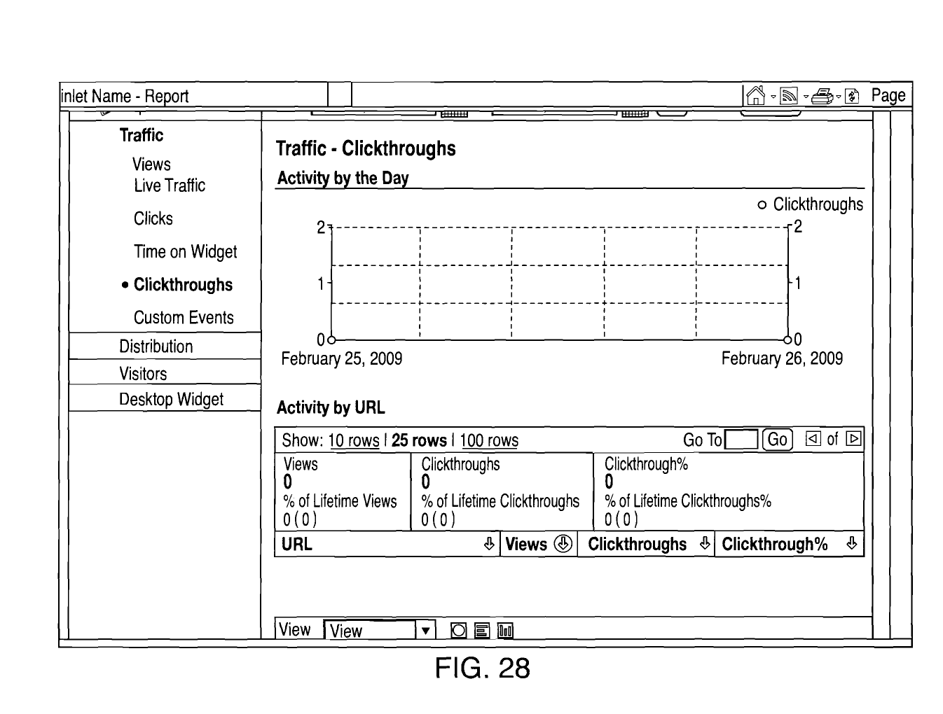

Traffic associated with clickthroughs may also be examined as may be seen in FIG. 28, for example. Clickthroughs may be displayed in a graphical display of activity by day with the days on the x-axis and the number of clickthroughs on the y-axis. Further, the activity may be displayed by URL, for example.

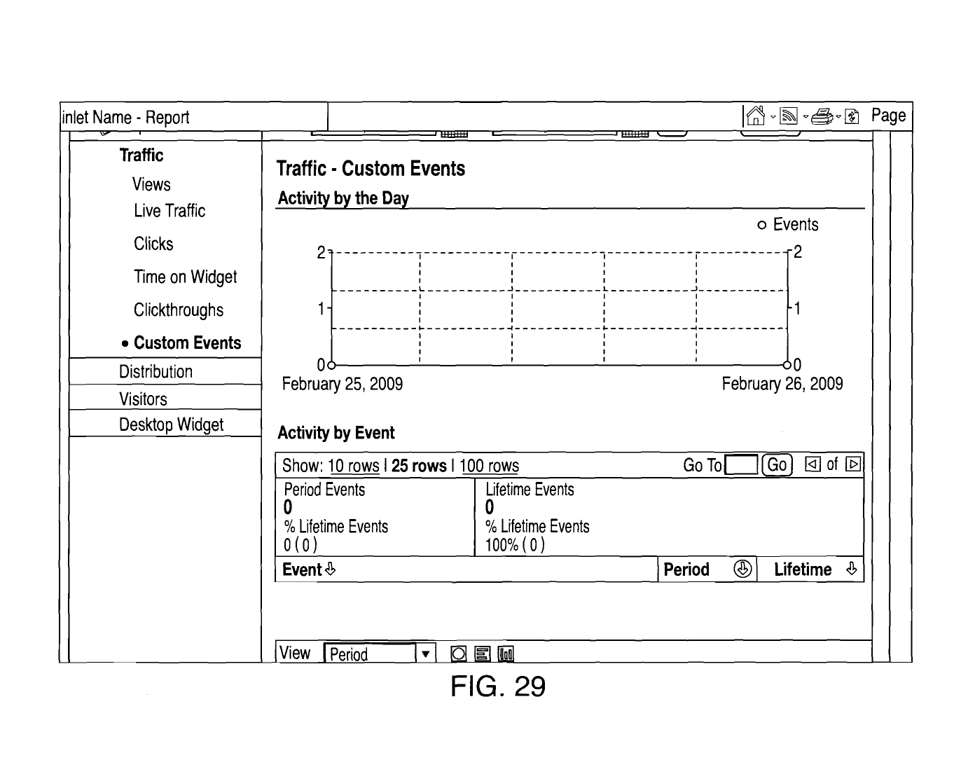

Traffic associated with custom events may also be tracked and displayed according to an aspect of the present invention. As may be seen in FIG. 29, there is shown activity by custom events, such custom events being user defined, or otherwise defined. Activity, by day, for custom events may be displayed as was discussed hereinabove, with the amount of activity on the y-axis and the day on the x-axis. Period events may be quantified, as well as lifetime events.

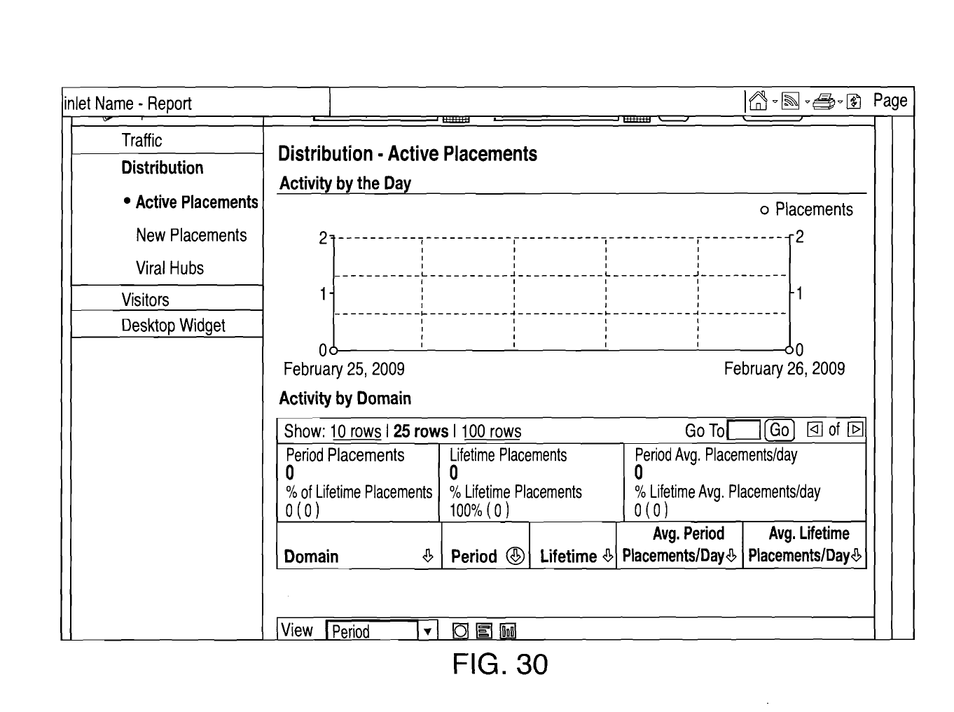

The present invention may provide information on active placements, new placements and viral hubs. As may be seen in FIG. 30, for example, the distribution of active placements may be seen. As previously discussed, the display of activity by day may be shown with the placements displayed on the y-axis and the day on the x-axis. This activity may be further shown as activity by domain, including period placements, lifetime placements and period average placements per day, by way of non-limiting example only.

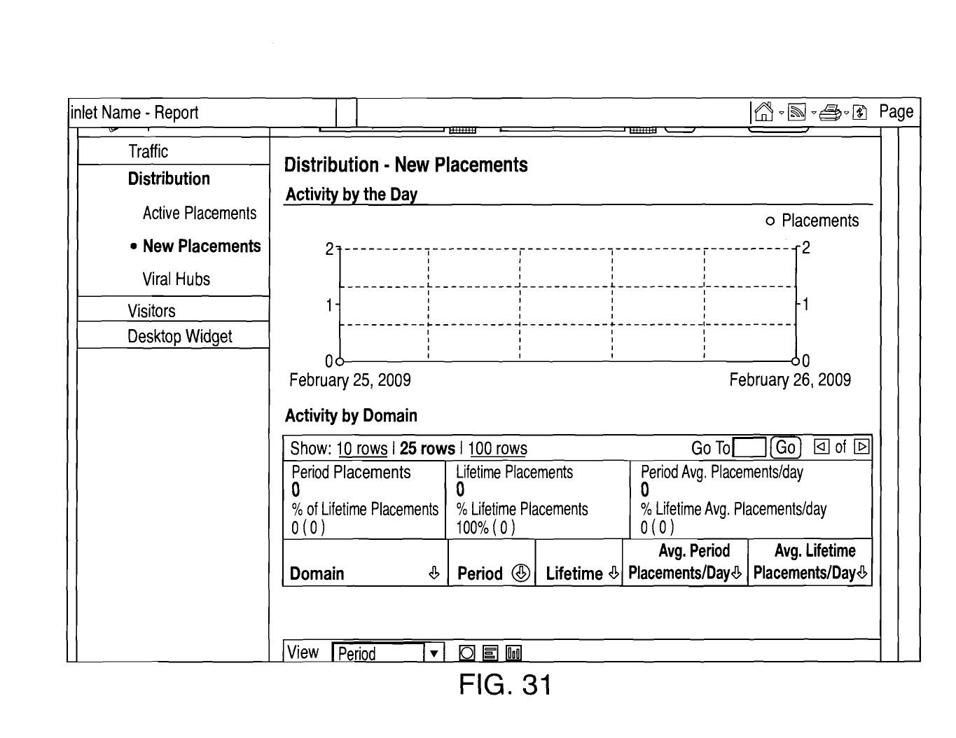

As may be seen on FIG. 31, for example, the distribution of new placements may be seen. This activity may be further shown as activity by domain including period new placements, lifetime new placements and period average new placements per day, by way of non-limiting example only.

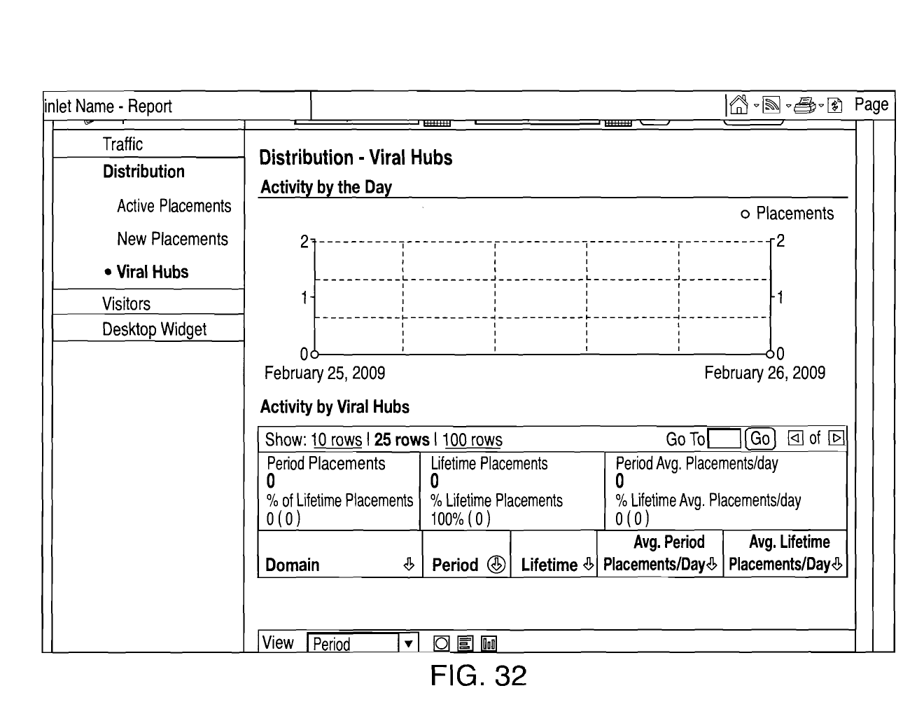

As may be seen on FIG. 32, for example, the distribution of viral hubs may be seen. This activity may further be shown as activity by domain including period placements, lifetime placements and period average placements per day, by way of non-limiting example only.

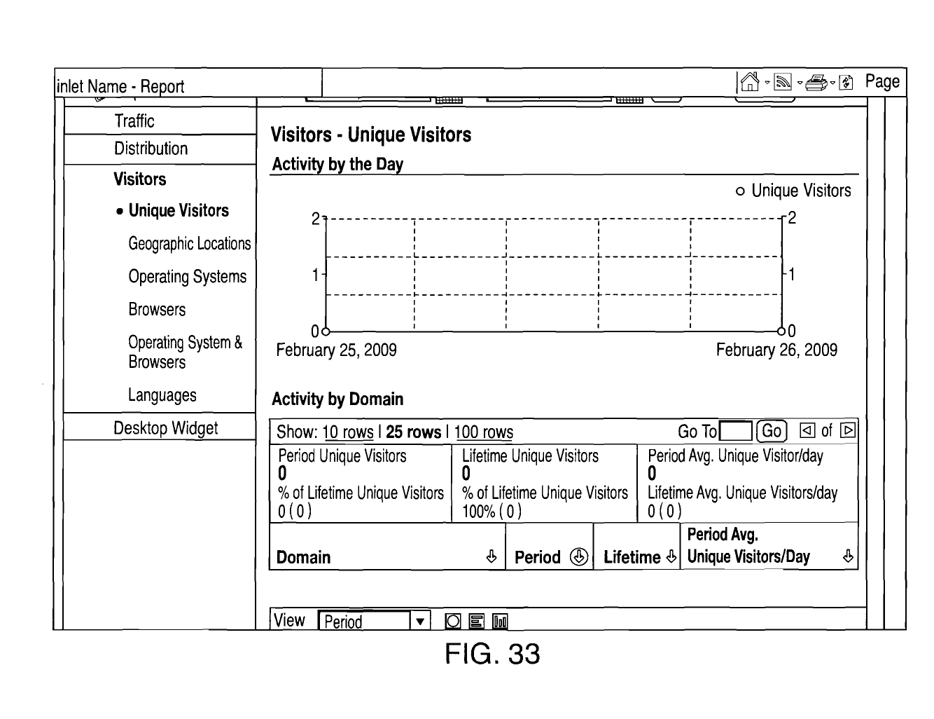

According to an aspect of the invention, and as is shown in FIG. 33, visitors may be monitored as unique visitors, such as based on the visitors geographic location, visitors' operating systems, visitors' browsers, visitors' languages, and combinations thereof. As may be seen in FIG. 33, the unique visitors may be displayed on the y-axis and the days of interest on the x-axis. Once again, activity by domain may be shown, including the number of unique visitors and the lifetime unique visitors, as well as the unique visitors per day in the life of the widget, for example.

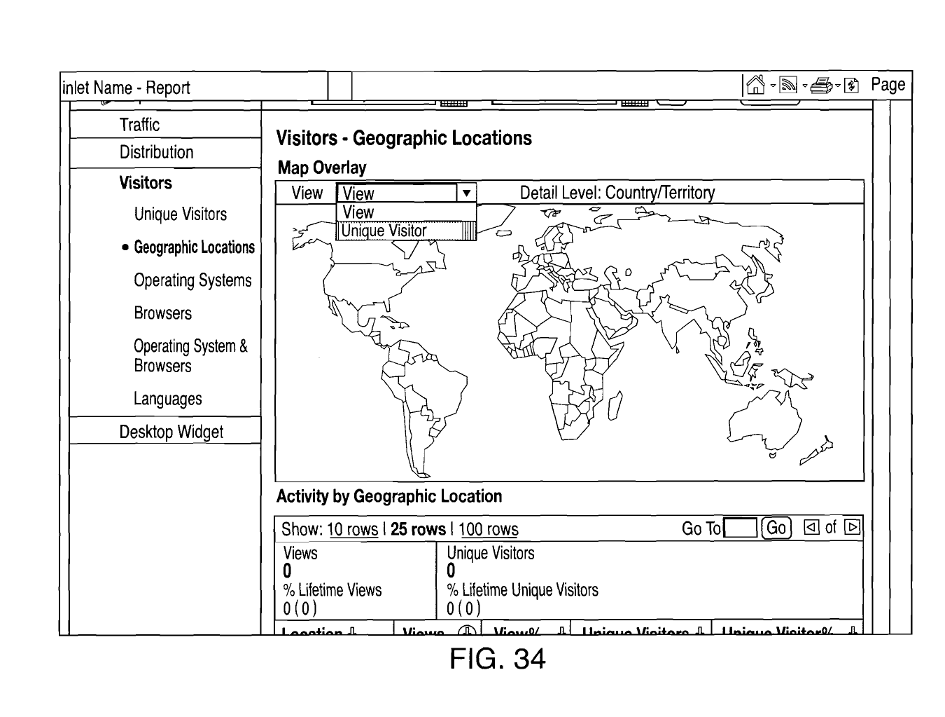

Referring now to FIG. 34, there is shown a graphical display of the visitors' geographic locations. As may be seen in FIG. 34, a display of the world is shown, and unique visitors may be overlayed based on their geographic locations.

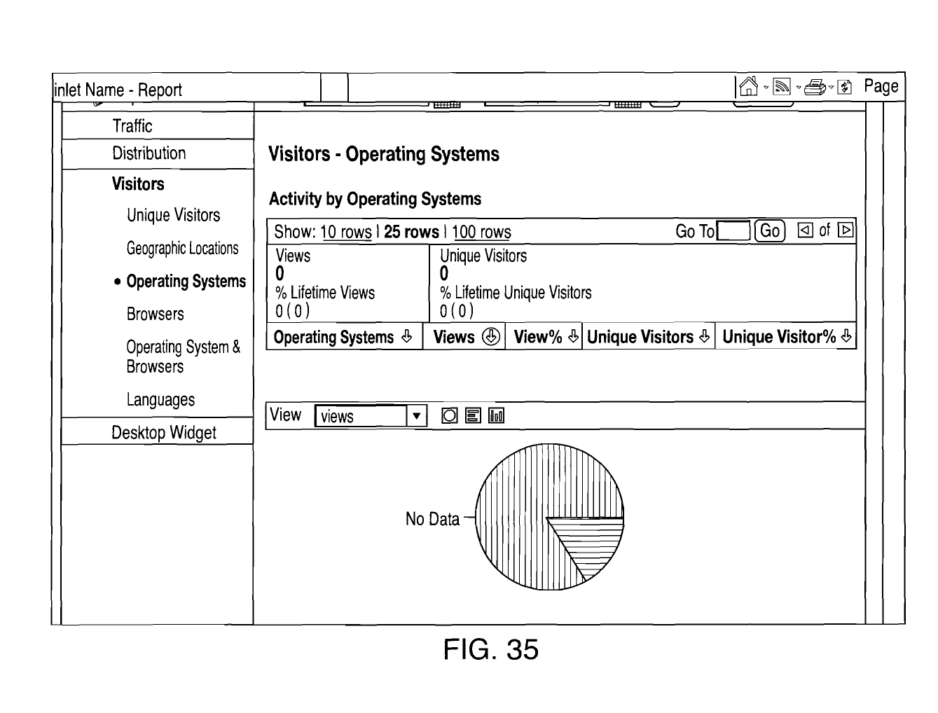

According to an aspect of the present invention, as may be seen in FIG. 35, the operating systems of visitors may be shown. This may be shown as a pie chart detailing the number of operating systems of a certain category as a function of all visitors' operating systems, for example.

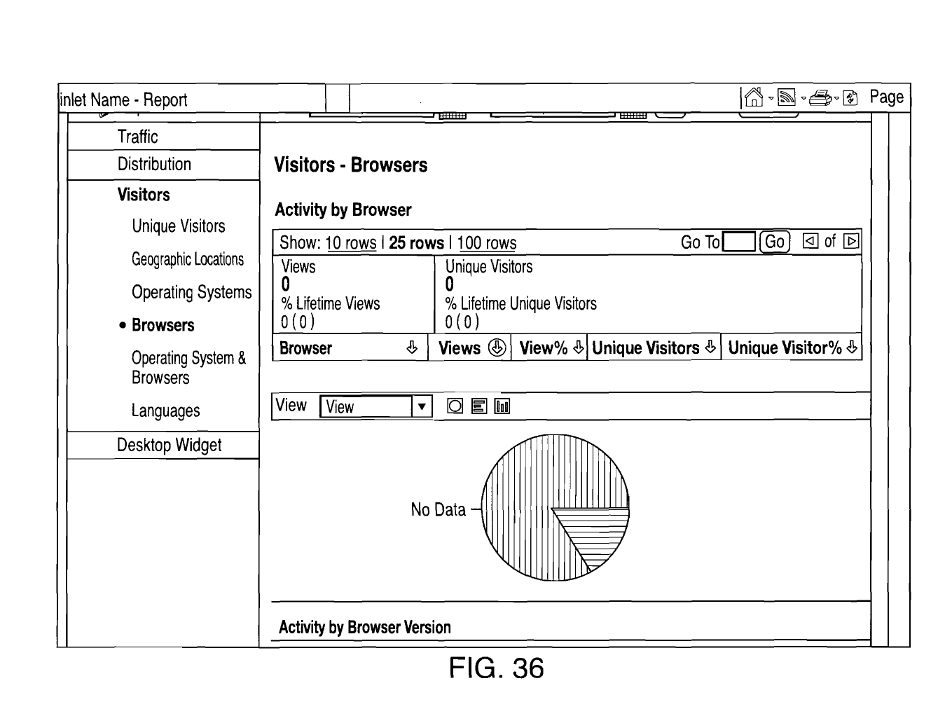

According to an aspect of the present invention, as may be seen in FIG. 36, the browser type for each visitor may be shown. This may be shown as a pie chart detailing the type of browser of a certain category as a function of all visitors' browsers, for example.

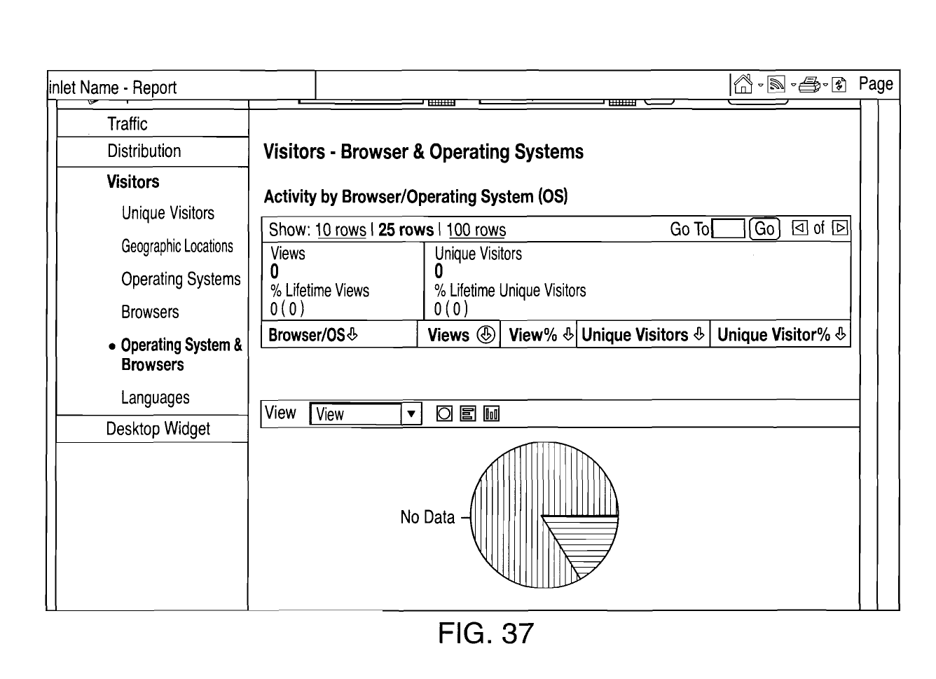

Similarly the browser and operating systems may be tied together. According to an aspect of the present invention, as may be seen in FIG. 37, the browser type and operating systems for each visitor may be shown. This may be shown as a pie chart detailing the combination of the browser type and operating system as a function of all visitors' combination of the browser type and operating system, for example.

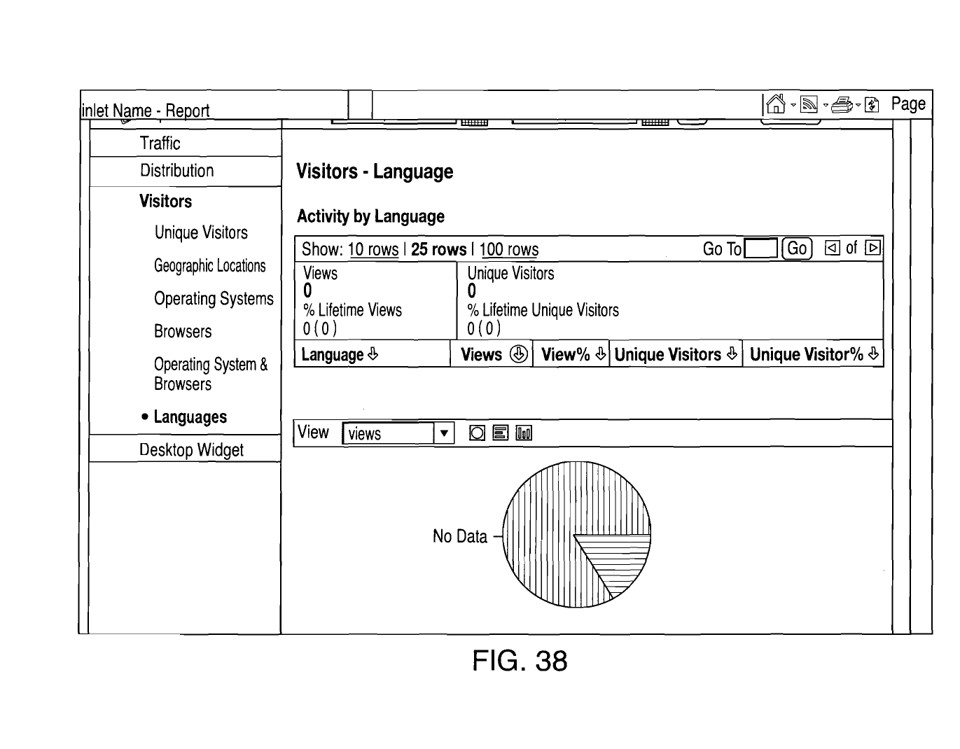

Similarly, and according to an aspect of the present invention, as may be seen in FIG. 38, the language for each visitor may be shown. This may be shown as a pie chart detailing the language of a certain category as a function of all visitors' languages, for example.

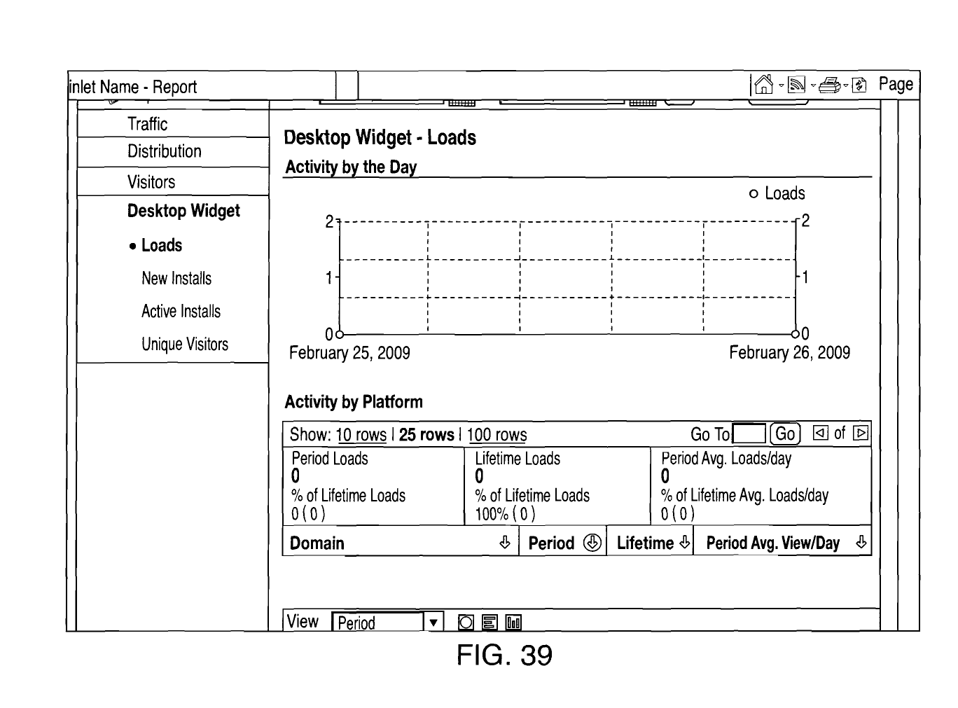

Turning now to the reporting of a desktop widget, and referring to FIG. 39, such reporting may take different views according to an aspect of the present invention. As may be seen in FIG. 39, loads, new installs, active installs and unique visitors may be reported. As may be further seen in FIG. 39, loads of desktop widgets may be graphically displayed as a function of the day of the load. A sum of the period loads, lifetime loads and period average loads per day may also be displayed.

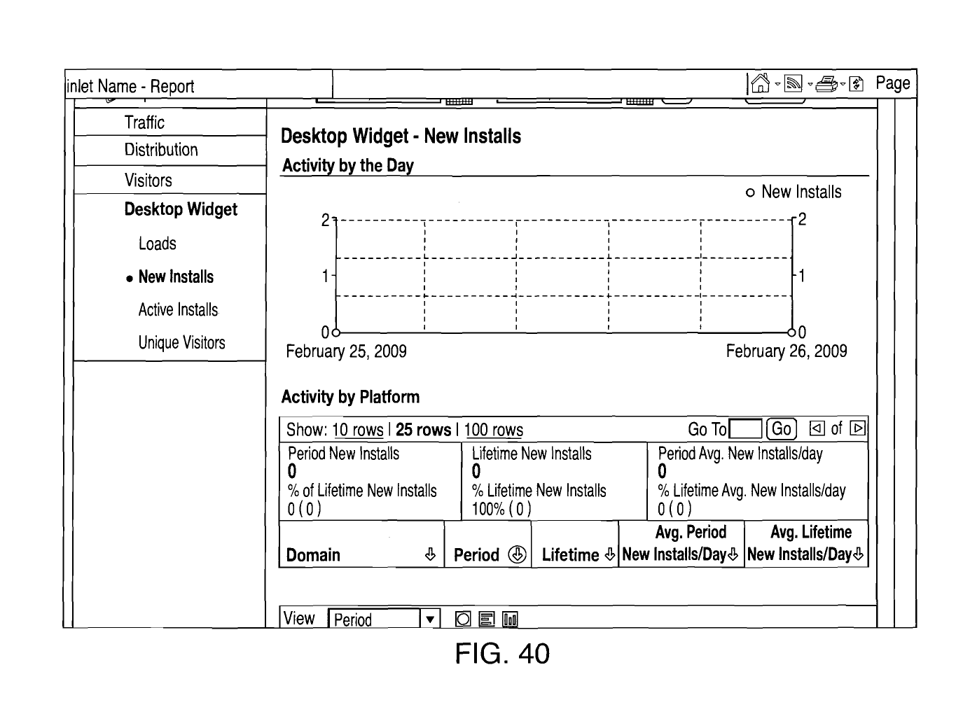

Referring now to FIG. 40, there is shown the reporting on new installs according to an aspect of the present invention. As may be seen in FIG. 40, new installs of desktop widgets may be graphically displayed as a function of the day of the new install. A sum of the new installs, lifetime new installs and period average new installs per day may also be displayed.

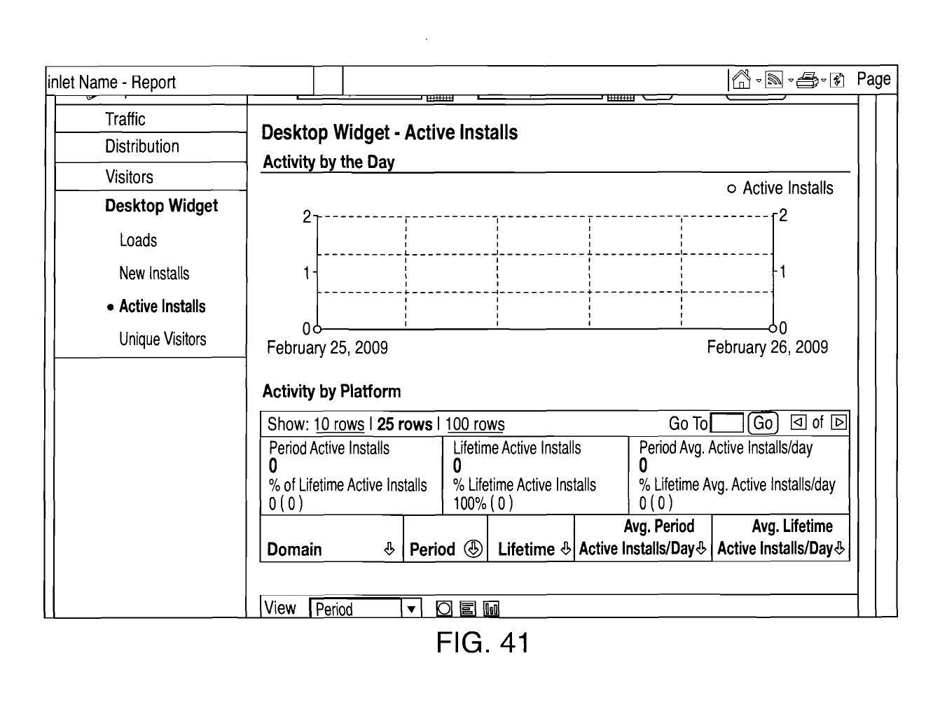

Referring now to FIG. 41, there is shown the reporting on active installs according to an aspect of the present invention. As may be seen in FIG. 41, active installs of desktop widgets may be graphically displayed as a function of the day of the active install. A sum of the active installs, lifetime active installs and period average active installs per day may also be displayed.

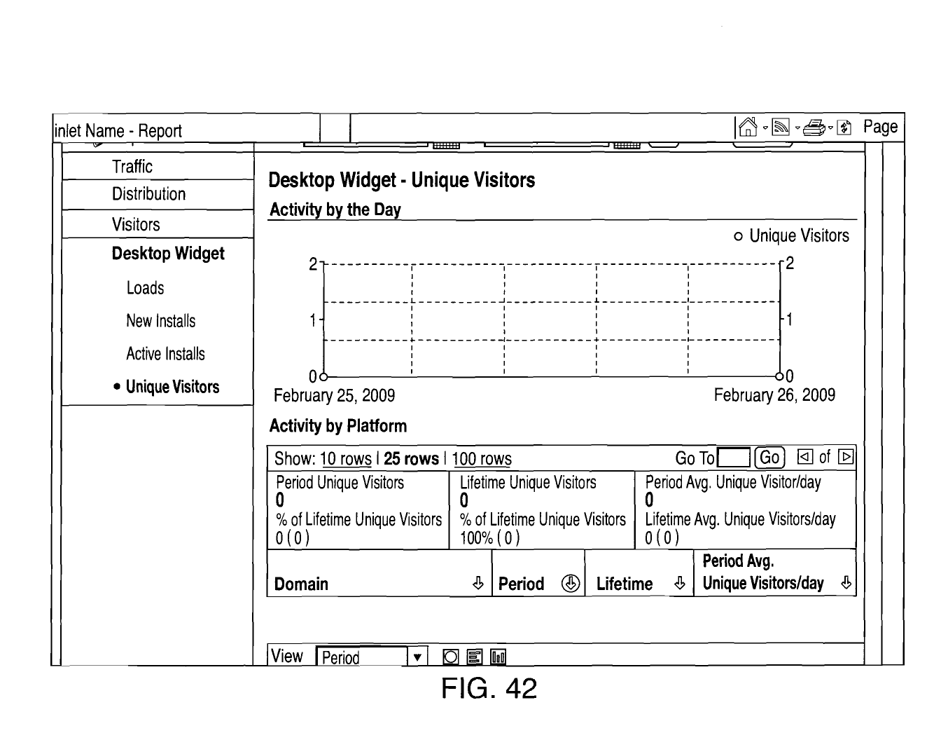

Referring now to FIG. 42, there is shown the reporting on unique visitors according to an aspect of the present invention. As may be seen in FIG. 42, unique visitors of desktop widgets may be graphically displayed as a function of the day of the unique visitors. A sum of the unique visitors, lifetime unique visitors and period average unique visitors per day may also be displayed.

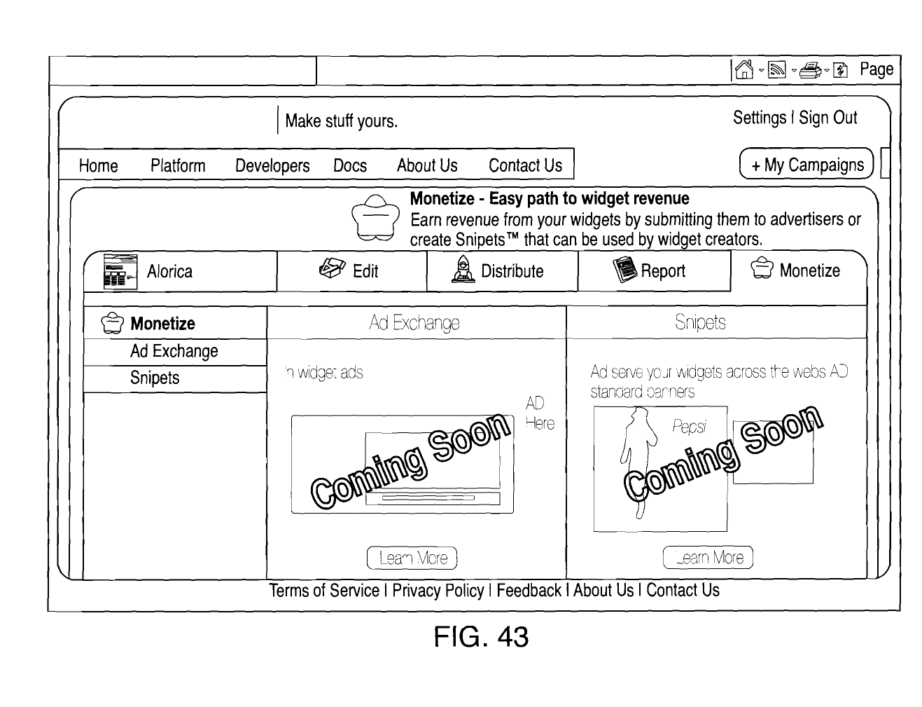

Referring now to FIG. 43, there is shown an aspect of the present invention designed to allow monetization of widgets. Monetization may provide opportunities and understanding to allow a user to generate revenue using widgets prepared, monitored and reported in accordance with the present technology. In particular, there is an ad exchange wherein in-widget ads may be used throughout an ad network. Further, snippets may be created that allow ad serving of widgets across the web in banners or the like.

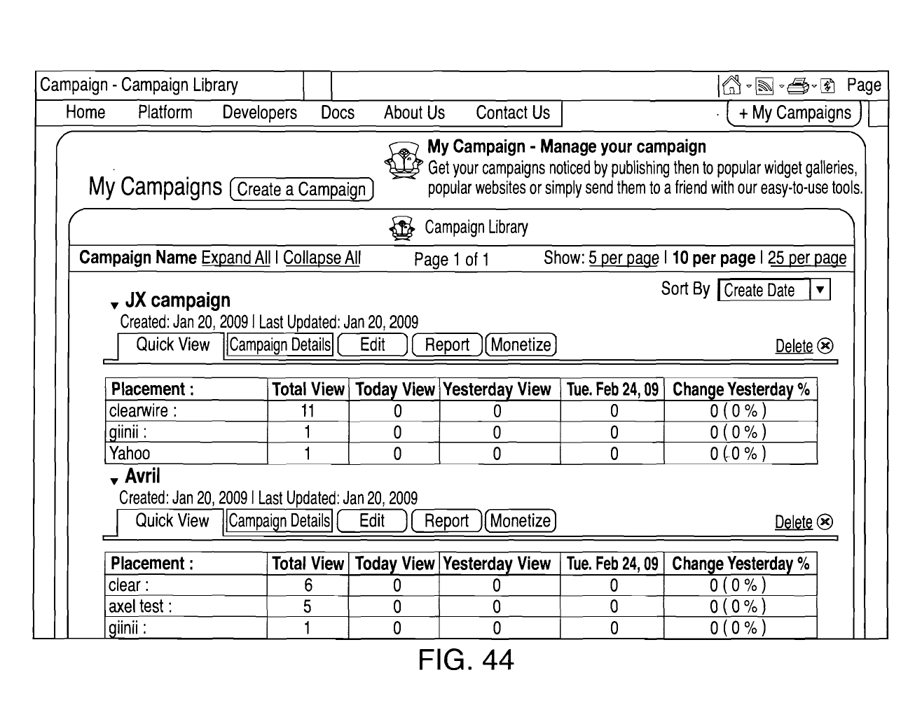

In addition to creating and managing widgets, the present invention may also provide the ability to group widgets together into campaigns of widgets. As may be seen in FIG. 44, a campaign may be created and managed according to an aspect of the present invention. Campaigns like the underlying widget itself may be published to widget galleries, websites, or delivered via email, by way of non-limiting example. The use of a campaign is similar to the description above related to individual widgets. As may be seen in FIG. 44, multiple campaigns may be created and managed according to an aspect of the present invention. As may be further seen in FIG. 44, there is created a JX campaign, according to an exemplary aspect of the present invention. The JX campaign according to this example includes three widgets, namely clearwire, giinii, and Yahoo by way of non-limiting example only. As with the widget parameters described hereinabove, campaigns may be edited, reported, and monetized. Total views, today views, yesterday's views and percent change in views may also be displayed.

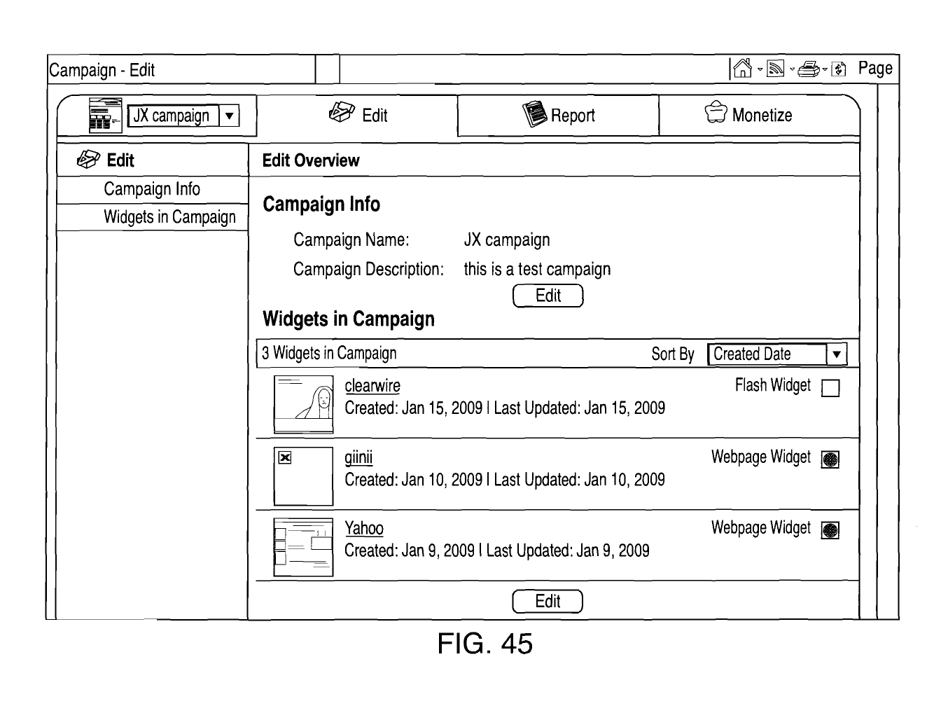

By clicking on an edit button for a campaign, a user may reach an edit campaign screen. Referring now to FIG. 45, there is shown a display designed to allow a user to edit a campaign. In editing a campaign, information may be obtained on the campaign and the widgets included in the campaign. The name of the campaign and the description of the campaign may be provided. Further, the widgets included in the campaign may be displayed with information on each widget provided, such as creation date, last edit date, and the type of widget. From this edit screen, two other screens may be entered in an exemplary embodiment: campaign info and widgets in the campaign.

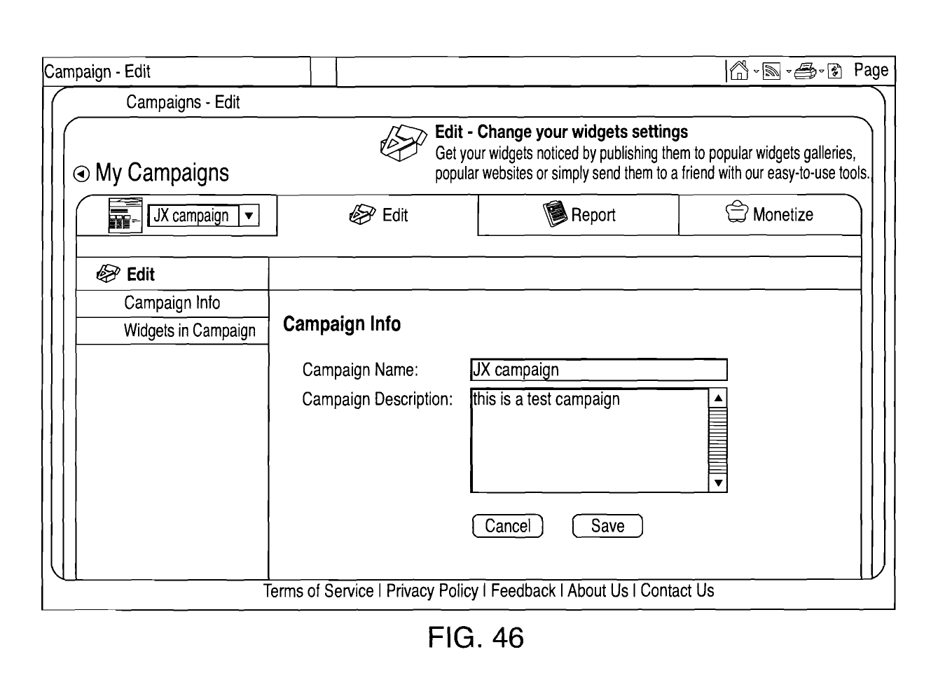

Referring now to FIG. 46, there is shown a display of the campaign info editing screen. From this screen, the campaign name, campaign description and campaign characteristics may be modified.

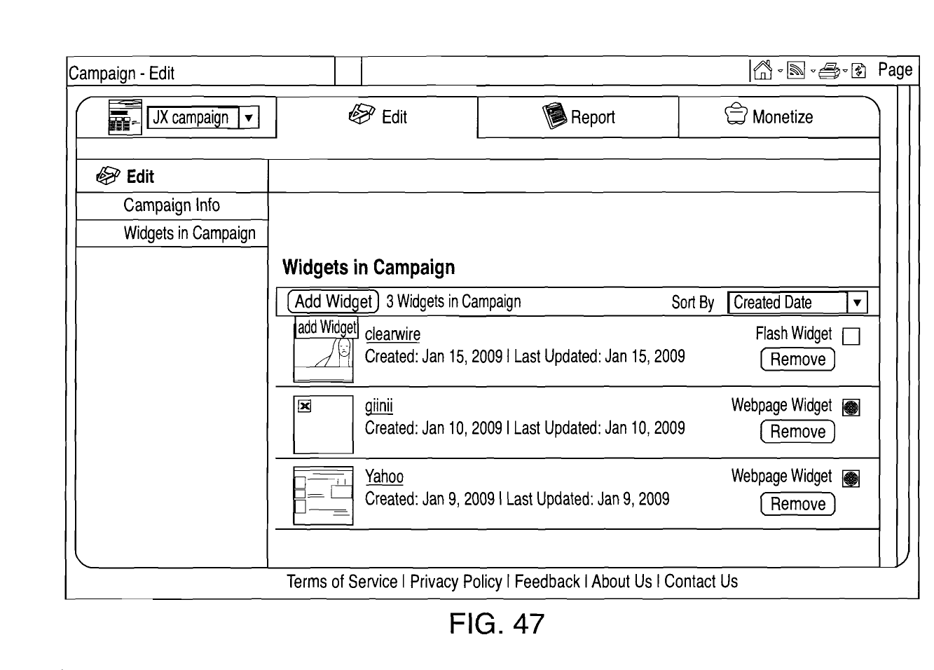

Referring now to FIG. 47, there is shown a display of the widgets in campaign editing screen. From this screen, the widgets in the campaign information may be provided, including creation of the widget, last edit date of the widget, and the type of widget. There may also be provided the ability to remove each widget included in the campaign.

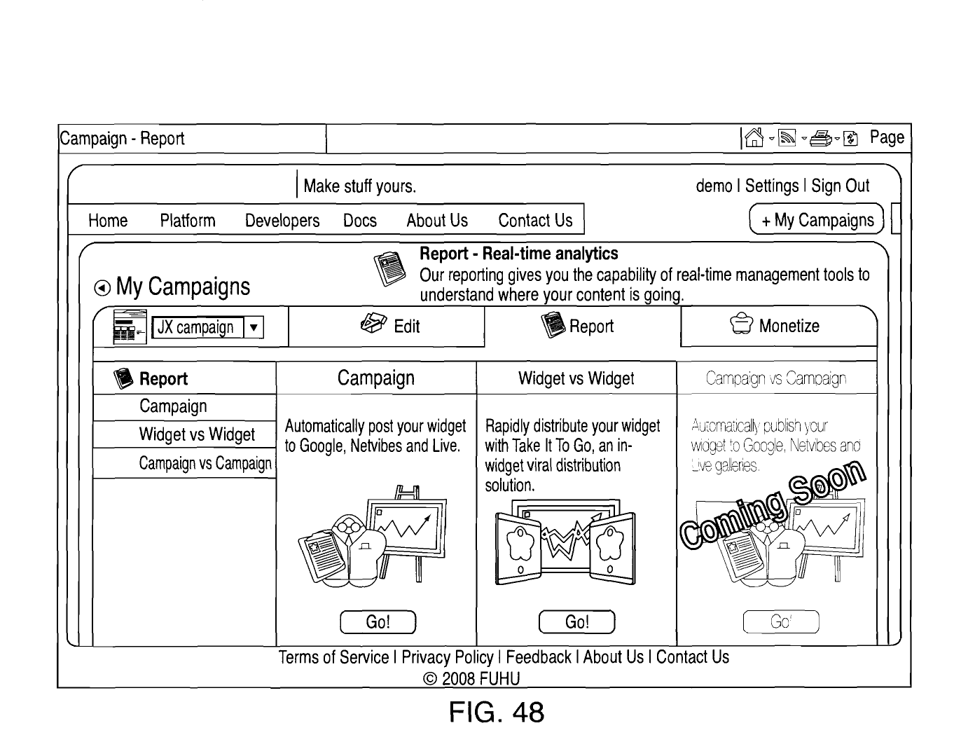

Referring now to FIG. 48, there is shown a display of the campaign reporting according to an aspect of the present invention. As may be seen in FIG. 48, the reporting may be broken into campaign, widget vs. widget, and campaign vs. campaign screens, for example.

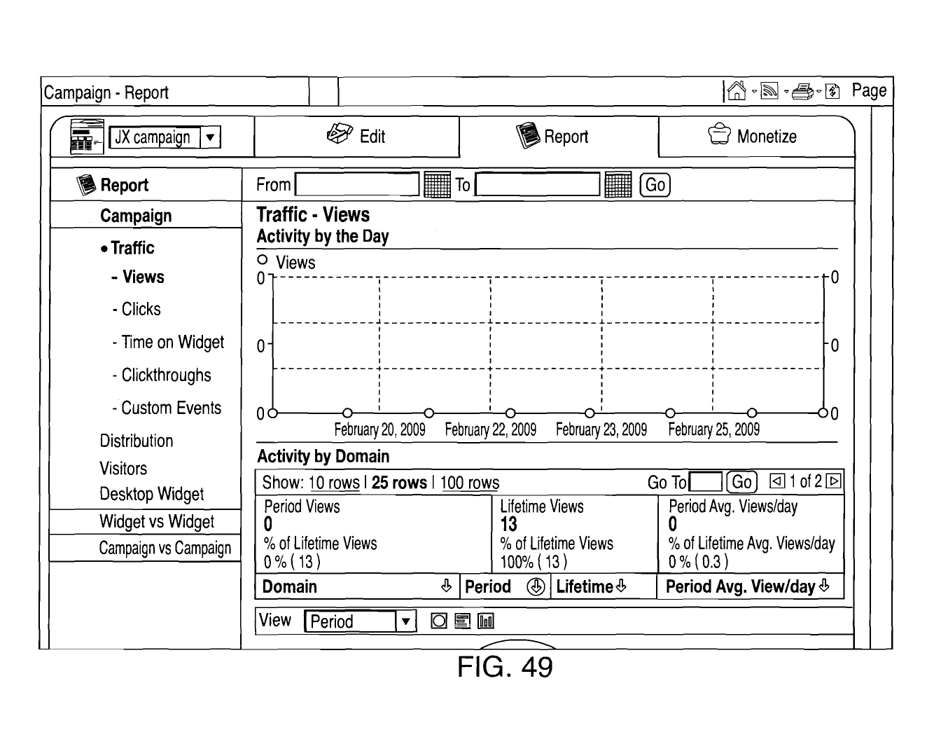

Referring now to FIG. 49, there is shown a display of the campaign reporting according to an aspect of the present invention. As may be seen, the reporting for the campaign may break down into traffic including views, clicks, time on widget, clickthroughs, and custom events, each of which is described hereinabove with respect to individual widgets. The reporting of campaigns may also include distribution, which may include active placements, new placements and viral hubs, each of which is described hereinabove with respect to widgets individually. The reporting of campaigns may also include visitors, which may include unique visitors, operating systems, browsers, operating systems and browsers, and languages, each of which is described hereinabove with respect to widgets individually. Further, reporting of campaigns may also include desktop widgets, which may include loads, active installs, new installs, and unique visitors, each of which is described hereinabove with respect to widgets individually.

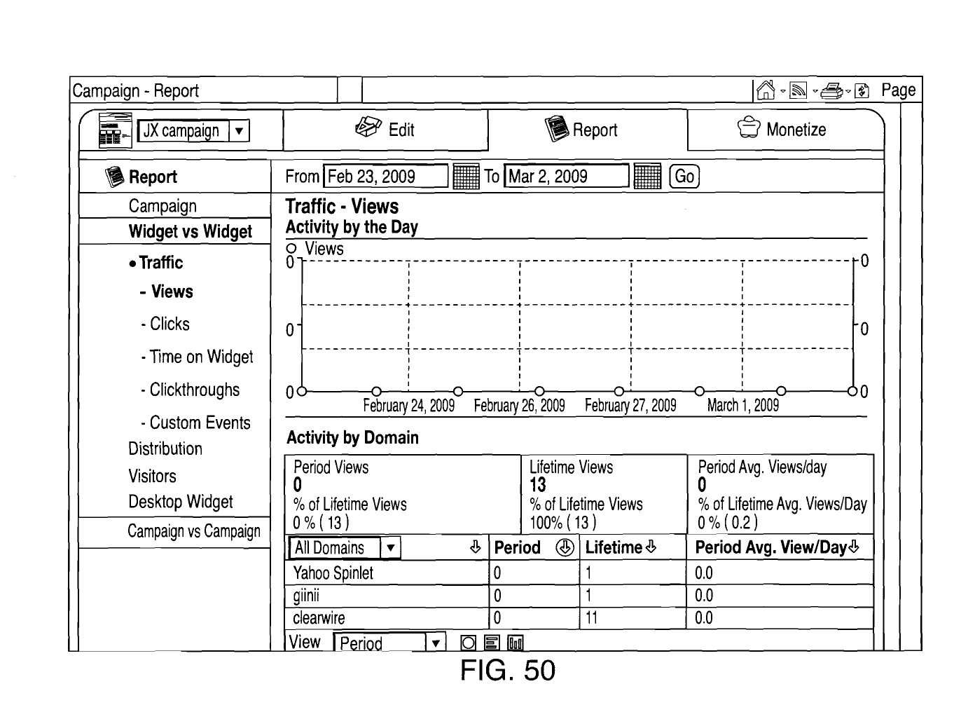

Referring now to FIG. 50, there is shown a display of reporting according to an aspect of the present invention. As may be seen, the reporting for the widget vs. widget breaks down into traffic, including views, clicks, time on widget, clickthroughs, and custom events, each of which is described hereinabove with respect to widgets individually. The reporting of widget vs. widget may also include distribution, which may include active placements, new placements and viral hubs, each of which is described hereinabove with respect to widgets individually. The reporting of widget vs. widget may also include visitors, which may include unique visitors, operating systems, browsers, operating systems and browsers, and languages, each of which is described hereinabove with respect to widgets individually. Further, reporting of widget vs. widget may also include desktop widget, which may include loads, active installs, new installs, and unique visitors, each of which is described hereinabove with respect to widgets individually.

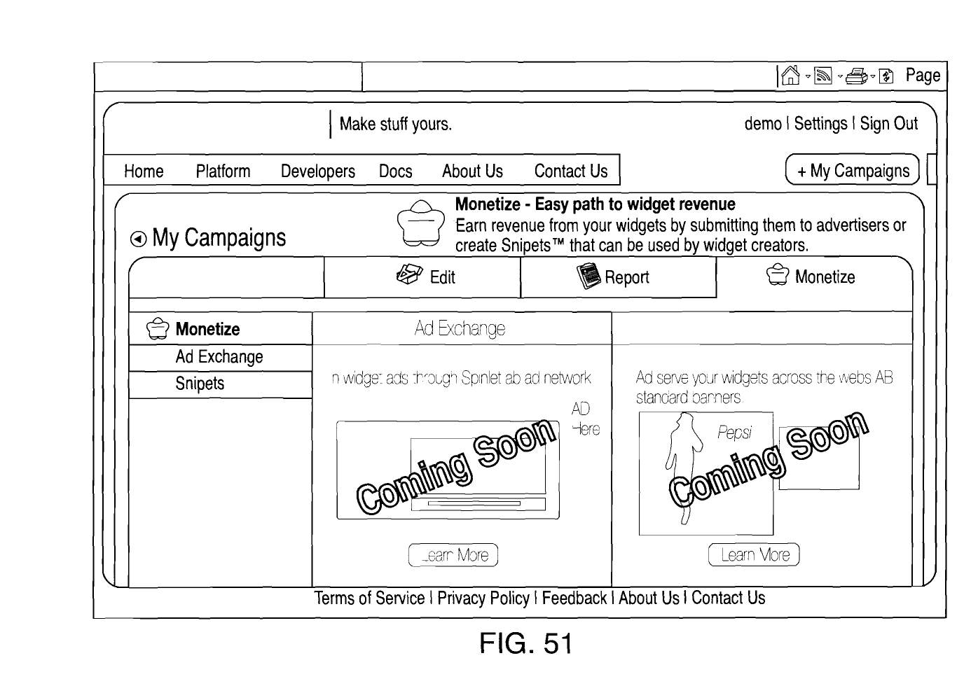

Referring now to FIG. 51, there is shown a display of the monetization options according to an aspect of the present invention. The present invention includes options for monetization, including ad exchange and snipets. The ad exchange may operate to provide in-widget ads through an ad network. Snipets may operate to ad serve widgets across the web, such as by using widgets in banners or the like.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A computerized development method for creating a widget designed to control streaming media, said method comprising:
creating a widget to control streaming media, said widget including a widgetized existing code element;
distributing said created widget;
reporting and tracking said distributed widget, wherein said reporting and tracking said distributed widget enables access to how said created widget is being used via analytics of said created widget; and,
monetizing said widget to generate revenue based on said created, distributed, and reported and tracked widget.

2. The method of claim 1, wherein said creating includes using at least one of a widgetizer, template and converter.

3. The method of claim 2, wherein said widgetizer widgetizes at least one of flash, html and gadgets.

4. The method of claim 2, wherein said template widgetizes at least one of a music/video, video player, music playlist and player, and photo slideshow.

5. The method of claim 2, wherein said converter widgetizes at least one of an image, blog or feed, and webpage.

6. The method of claim 1, wherein said distributing includes distributing using at least one of posting, sharing, Facebook and galleries.

7. The method of claim 6, wherein said posting and sharing distributes to at least one of iGoogle.com, Blogger, Blogger Sidebar, Live.com, My Yahoo!, AOL Bookmarks, Ask MyStuff, BackFlip, del.icio.us, Digg, Diigo, DropJack, Eons, Faves, Furl, Google Bookmarks, Linkagogo, Live Favorites, Mister Wong, NetVibes, Newsvine, PageFlakes, Piczo, Propeller, Reddit, Segnalo, Simpy, Skimbit, SlashDot, Spurl, StumbleUpon, Technorati, Twitter, TypePad, TypePad Sidebar, Webwag, Yahoo! Bookmarks, and Get Code.

8. The method of claim 6, wherein said galleries includes distributing using at least one of Google gadget gallery and Live gadget gallery.

9. The method of claim 1, wherein said reporting includes reporting at least one of unique visitors, traffic monitoring, clicks, time on widget, clickthroughs, and distribution reporting.

10. The method of claim 1, wherein said monetizing includes monetizing using at least one of an ad exchange and snippets.

11. A computerized method for widgetizing control of streaming media, said method comprising:
locally providing a widget comprising a plurality of code elements, in which at least one of the code elements is interoperable with an existing code element on a device, and at least one of the code elements is interoperable with at least each of an existing service on the device, remotely distributing a content stream generated externally to the device, and a network interface of the device;
distributing at least one instruction to the network interface tracking said distributing, wherein said tracking enables access to how the widget is being used in said modifying via analytics of said created widget; and
monetizing said tracking.

12. The method of claim 11, wherein said locally providing includes using at least one of a widgetizer, template and converter.

13. The method of claim 12, wherein said widgetizer widgetizes at least one of flash, html and gadgets.

14. The method of claim 12, wherein said template widgetizes at least one of a music/video, video player, music playlist and player, and photo slideshow.

15. The method of claim 12, wherein said converter widgetizes at least one of an image, blog or feed, and webpage.

16. The method of claim 11, wherein said distributing includes distributing using at least one of posting, sharing, Facebook and galleries.

17. The method of claim 16, wherein said posting and sharing distributes to at least one of iGoogle.com, Blogger, Blogger Sidebar, Live.com, My Yahoo!, AOL Bookmarks, Ask MyStuff, BackFlip, del.icio.us, Digg, Diigo, DropJack, Eons, Faves, Furl, Google Bookmarks, Linkagogo, Live Favorites, Mister Wong, NetVibes, Newsvine, PageFlakes, Piczo, Propeller, Reddit, Segnalo, Simpy, Skimbit, SlashDot, Spur!, StumbleUpon, Technorati, Twitter, TypePad, TypePad Sidebar, Webwag, Yahoo! Bookmarks, and Get Code.

18. The method of claim 16, wherein said galleries includes distributing using at least one of Google gadget gallery and Live gadget gallery.

19. The method of claim 11, wherein said monitoring and tracking includes reporting at least one of unique visitors, traffic monitoring, clicks, time on widget, clickthroughs, and distribution reporting.

20. The method of claim 11, wherein said monetizing includes monetizing using at least one of an ad exchange and snippets.
